(19) United States
(12) Patent Application Publication
(10) Pub. No.: US 2026/0289467 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/564,557

(22) Filed: Mar. 12, 2026

(30) Foreign Application Priority Data
Mar. 19, 2025 (JP) 2025-044945

(51) Int. Cl. G06Q 10/0637; G06N 3/0475

(52) U.S. Cl. CPC G06Q 10/0637; G06N 3/0475

(57) ABSTRACT

A system includes a processor that is configured to collect data necessary for strategic decision making, preprocess the collected data and input a prompt to a generative AI model to instruct the generative AI model to determine whether an offensive strategy or a defensive strategy should be adopted, and propose defensive measures based on a result of the determination.

### CROSS-REFERENCE TO RELATED APPLICATION

This application is based on and claims priority under 35 USC 119 from Japanese Patent Application No. 2025-044945 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional management support systems and decision support tools are not capable of flexibly utilizing generative artificial intelligence models in order to formulate high-level strategic decisions such as whether an organization should adopt an offensive strategy or a defensive strategy. Existing systems typically rely on static rule sets, fixed scoring models, or manually prepared scenarios, and therefore cannot adequately capture complex and rapidly changing combinations of market data, management indicators, and risk factors. As a result, decision makers such as executives and managers are required to manually interpret disparate data sources, to construct their own analytical frameworks, and to derive appropriate defensive measures without systematic support. Furthermore, conventional systems do not provide a mechanism for generating prompts to a generative AI model in a manner tailored to the needs of different management layers, nor do they dynamically update such prompts in response to real-time market and competitive information. Consequently, there is a need for a system that automatically collects and preprocesses data required for strategic decision making, generates appropriate prompts for a generative AI model to determine whether an offensive or defensive strategy should be adopted, proposes defensive measures based on the determination, and further provides role-specific strategic judgments and real-time adaptive responses under changing external conditions.

### SUMMARY

In order to solve the above-described problems, according to one aspect of the present invention, there is provided a system comprising a processor, wherein the processor is configured to collect data necessary for strategic decision making, preprocess the collected data, input a prompt to a generative AI model to instruct the generative AI model to determine whether an offensive strategy or a defensive strategy should be adopted, and propose defensive measures based on a result of the determination. According to another aspect of the present invention, the processor is further configured to receive, via a user interface, management indicators and risk factors for providing strategic decisions specialized for executives and managers, and generate a prompt that instructs the generative AI model to perform a strategic decision based on the management indicators and the risk factors, thereby enabling provision of role-specific strategic recommendations corresponding to different management layers. According to a further aspect of the present invention, the processor is configured to collect market data and competitive information in real time, dynamically update the prompt by using the generative AI model, and instruct the generative AI model to perform a strategic decision, thereby allowing the system to continuously adapt its strategic recommendations and defensive measures in response to fluctuations in the external environment.

The term “system” refers to an arrangement of one or more hardware devices, software components, and communication interfaces that cooperatively perform the functions described in the claims.

The term “processor” refers to any hardware component or combination of components capable of executing instructions, including but not limited to a central processing unit (CPU), a graphics processing unit (GPU), a microcontroller, a digital signal processor, an application specific integrated circuit (ASIC), a field programmable gate array (FPGA), or a combination thereof.

The term “data necessary for strategic decision making” refers to any information used to support determination of an offensive or defensive strategy, including, for example, market data, economic indicators, management indicators, risk factors, and competitive information.

The term “collect” refers to obtaining data from one or more sources, such as external databases, application programming interfaces (APIs), sensors, internal information systems, or user inputs, and storing the obtained data in a memory accessible by the processor.

The term “preprocess” refers to performing one or more operations on collected data prior to inputting the data to a generative AI model, including, for example, cleaning, normalizing, transforming, aggregating, filtering, or formatting the data.

The term “generative AI model” refers to an artificial intelligence model that generates output data, such as text, numerical values, or other structured information, in response to an input prompt, and includes, for example, large language models and other generative models.

The term “prompt” refers to an input text or structured input sequence provided to a generative AI model, the content of which instructs or guides the generative AI model to perform a specific task, such as determining whether an offensive strategy or a defensive strategy should be adopted.

The term “offensive strategy” refers to a strategic direction in which an organization conducts proactive activities aimed at expansion, such as market entry, investment, growth initiatives, or competitive attacks.

The term “defensive strategy” refers to a strategic direction in which an organization prioritizes protection and preservation, such as risk reduction, cost control, retention of existing customers, or protection of existing market share.

The term “determine whether an offensive strategy or a defensive strategy should be adopted” refers to generating a judgment or recommendation, based at least in part on collected and preprocessed data, that classifies a strategic direction into an offensive strategy or a defensive strategy.

The term “defensive measures” refers to specific recommended actions or policies to be implemented under a defensive strategy, including, for example, cost reductions, risk mitigation actions, compliance enhancements, or customer retention initiatives.

The term “result of the determination” refers to the output of the generative AI model that indicates whether an offensive strategy or a defensive strategy is recommended, and may include a classification, a score, a probability, or explanatory information.

The term “user interface” refers to any interface that enables a user to input or receive information to or from the system, including, for example, a graphical user interface, a web browser interface, a mobile application interface, or an application programming interface used by another system.

The term “management indicators” refers to quantitative or qualitative indicators representing the status or performance of an organization, such as sales, profit, cash flow, key performance indicators (KPIs), or financial ratios.

The term “risk factors” refers to variables or conditions that may adversely affect an organization's performance or objectives, such as market risk, credit risk, operational risk, regulatory risk, geopolitical risk, or technology risk.

The term “strategic decisions specialized for executives and managers” refers to strategic recommendations that are structured or expressed in a form suitable for use by executives or management personnel, considering their responsibilities, scope of authority, and information needs.

The term “perform a strategic decision” refers to generating, by the generative AI model, an output that recommends or supports a particular strategic direction or set of actions for an organization.

The term “market data” refers to information related to markets in which an organization operates, including, for example, sector growth, demand trends, price movements, and competitor share.

The term “competitive information” refers to information about competitors or potential competitors, such as competitor strategies, market shares, product offerings, pricing, and activities.

The term “in real time” refers to performing processing with a latency that is sufficiently short to reflect current or near-current conditions, such that updated data and corresponding strategic decisions are available without substantial delay for practical decision making.

The term “dynamically update the prompt” refers to modifying the content of a prompt to the generative AI model based on newly collected data or changed conditions, such that the task or instructions given to the generative AI model are adaptively revised.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

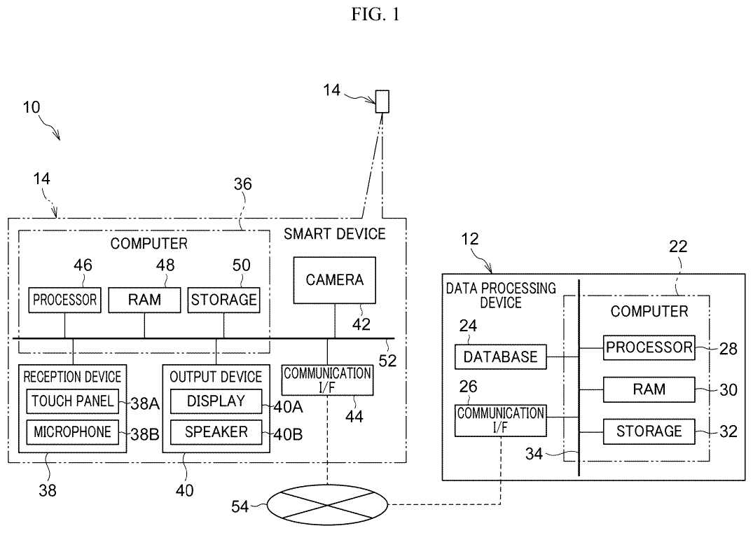

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

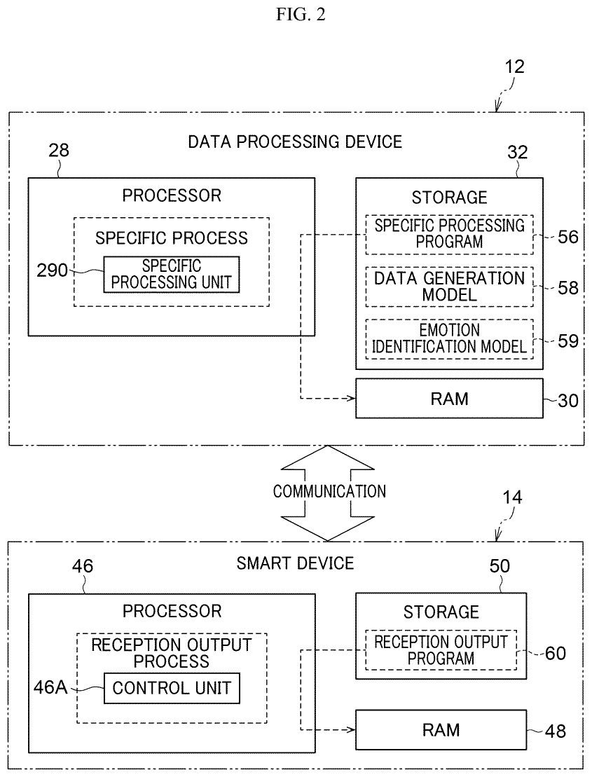

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional decision-support systems for business strategy typically treat artificial intelligence models as black-box advisors that simply receive manually prepared input text and return high-level recommendations. In such systems, human operators must perform substantial preprocessing and summarization of heterogeneous business data, including sales figures, cost data, market indices, and risk indicators, before the data can be input to a generative AI model. This manual intervention introduces latency, inconsistency, and operator bias, and prevents the system from responding efficiently to rapidly changing business environments.

Furthermore, known systems generally do not integrate structured feedback loops that close the cycle between model output, user adoption of recommendations, and actual execution results. As a consequence, the systems are unable to automatically refine the way in which prompts are constructed for the generative AI model based on historical performance of proposed strategies. The interaction pattern between the computing infrastructure and the generative AI model thus remains static and brittle, leading to suboptimal use of computational resources and degraded quality of strategic judgments over time.

In addition, existing architectures often process numerical business data and unstructured model outputs in separate, loosely coupled modules, without a systematic mechanism for transforming raw multi-dimensional data into machine-generated natural language summaries that are optimized for prompt sentences. This fragmentation leads to inefficient data pipelines, increased processing overhead, and difficulty in scaling the system to handle continuous inflows of market information and competitor information. It also impedes the automatic generation of consistent and comprehensive prompts that capture the most salient indicators for offensive (“attack”) or defensive (“defend”) strategies.

Moreover, prior approaches fail to dynamically adapt prompt structures and model conditions in response to accumulated feedback and environmental changes. While the underlying generative AI model may be powerful, the overall system does not improve its behavior as a computing system: the data ingestion, preprocessing, summarization, prompt construction, and feedback utilization remain largely fixed. As a result, the computer system cannot fully leverage its storage, processing, and communication resources to achieve more accurate, context-aware, and time-sensitive strategic decisions.

Accordingly, there is a need for a computer-implemented system that automatically acquires and preprocesses business and environmental information, converts such information into structured natural-language summaries, constructs optimized prompt sentences for a generative AI model, and feeds back user adoption data and execution results into the system to iteratively refine the prompt generation logic. There is also a need for such a system to operate in real time or near real time with respect to changing market and competitor information, thereby improving the overall functioning of the computer infrastructure used to support strategic decision making.

The specific processing by the specific processing unit 290 of the data processing device 12 in Example 1 is realized by the following means.

The present invention provides a server comprising a processor and a storage device, the processor being configured to obtain business information and environmental information from a terminal and an external information source, store the information in the storage device, perform numerical preprocessing and data analysis on the stored information to generate normalized indicator values, automatically convert the indicator values into natural-language summary text, automatically construct a prompt sentence including the summary text and explicit instructions for a generative AI model to determine whether an offensive or defensive strategy should be taken and to propose specific measures, transmit the prompt sentence to the generative AI model and receive a response comprising a strategic decision, reasons, and proposed measures, parse and structure the response, refine at least defensive measures based on historical business information and past measure execution results stored in the storage device, deliver structured strategy proposal information to the terminal, and record feedback from the terminal regarding adoption and execution results, and further update, based on the recorded feedback and the stored information, at least one of a structure of subsequent prompt sentences and conditions supplied to the generative AI model so as to generate learning data for improving prompt generation. This enables an improvement in the operation of the computer system by automating end-to-end data acquisition, preprocessing, summarization, prompt construction, and feedback-driven refinement of the interaction with the generative AI model, thereby reducing manual intervention, increasing consistency and responsiveness of strategic decision support, and adaptively optimizing the use of computational resources and model capabilities over time.

The term “system” refers to a combination of hardware and software components including at least one processor, at least one storage device, and at least one terminal, which cooperate over a communication network to execute the claimed processing.

The term “processor” refers to one or more hardware-based processing units, such as a central processing unit, a graphics processing unit, or a programmable logic device, configured by software instructions to perform data acquisition, data processing, prompt generation, communication, and control operations described in the claims.

The term “storage device” refers to any non-transitory computer-readable medium, such as a magnetic disk, an optical disk, a solid-state memory, or a storage array, capable of storing programs, business information, environmental information, indicator values, response sentences, feedback information, and learning data.

The term “terminal” refers to an information processing apparatus, such as a client computer, a mobile communication device, or a display device, that communicates with the server, provides user interfaces, transmits input data to the server, and receives and displays strategy proposal information.

The term “business information” refers to structured or unstructured data representing operational states of an organization, including at least sales data, cost data, profit-related data, management indexes, and internal risk factors used for strategic decision making.

The term “environmental information” refers to data representing external conditions surrounding an organization, including at least market information, competitor information, and other external indicators used to evaluate strategic risks and opportunities.

The term “data accumulation” refers to the process in which the processor stores received business information, environmental information, response sentences, and feedback information into the storage device in association with identifiers and time information.

The term “numerical computation program” refers to a software component that performs arithmetic processing on numerical data, including at least operations for calculating growth rates, averages, variances, and normalized values.

The term “data analysis program” refers to a software component that processes and analyzes data, including at least functions for handling missing values, detecting abnormal values, integrating heterogeneous data, and computing indicator values from business information and environmental information.

The term “preprocessing” refers to a series of operations performed on raw business information and environmental information, including at least completion of missing values, removal of abnormal values, normalization, and alignment of data along a common scale or time axis.

The term “indicator value” refers to a numerical or categorical value derived from preprocessed data, representing a summarized characteristic of the data, such as a sales trend, a profit margin trend, a market growth rate, or a cancellation rate.

The term “sales trend” refers to an indicator value or set of values representing temporal variations of sales amounts, such as growth rates or declining rates over a plurality of time periods.

The term “profit margin trend” refers to an indicator value or set of values representing temporal variations in profit margins, such as changes in gross margin or operating margin across time.

The term “market growth rate” refers to an indicator value representing an amount or rate of increase or decrease of a relevant market size over a specified period.

The term “cancellation rate” refers to an indicator value representing a proportion of customers or contracts that have been terminated or not renewed in a given period.

The term “summary information” refers to data that includes a plurality of indicator values derived from preprocessed business information and environmental information and that expresses the overall situation for strategic decision making in a condensed form.

The term “explanatory text” refers to natural-language text generated by the processor, which describes the content of the summary information in a human-readable narrative form.

The term “prompt sentence” refers to natural-language text or a structured set of natural-language messages that includes at least explanatory text and an instruction sentence, and that is provided as input to a generative AI model to request generation of a response.

The term “instruction sentence” refers to a portion of a prompt sentence that gives explicit instructions to the generative AI model regarding tasks to be performed, including at least selection of an offensive strategy or a defensive strategy and generation of specific measures consistent with the selected strategy.

The term “generative information processing model” refers to a machine-learned model, such as a generative AI model, that receives a prompt sentence and generates natural-language text or other data based on patterns learned from training data.

The term “response sentence” refers to natural-language text generated by the generative information processing model in response to a prompt sentence, the text including at least a strategic decision, reasons for the decision, and proposed measures.

The term “strategic decision” refers to a determination, produced by the generative information processing model or by the processor based on model outputs, indicating whether an offensive strategy “attack” or a defensive strategy “defend” should be adopted.

The term “proposed measure” refers to a specific action or plan, generated or selected based on a strategic decision, that can be executed by an organization to advance an offensive strategy or implement a defensive strategy.

The term “protection measure” refers to a particular type of proposed measure that is associated with a defensive strategy and that is intended to reduce risk, limit loss, or stabilize business performance.

The term “offensive measure” refers to a particular type of proposed measure that is associated with an offensive strategy and that is intended to expand business, increase revenue, or capture new opportunities.

The term “past measure execution result” refers to data stored in the storage device representing historical execution of measures, including at least whether measures were adopted, how they were implemented, and what outcomes were obtained.

The term “strategy proposal information” refers to structured data transmitted from the processor to the terminal, including at least a strategic decision, reasons for the strategic decision, and one or more of a protection measure and an offensive measure.

The term “feedback information” refers to data obtained from the terminal indicating evaluation of strategy proposal information, including at least adoption information representing whether proposed measures are adopted or rejected, and execution result information representing outcomes of executed measures.

The term “adoption information” refers to a part of feedback information that indicates, for each proposed measure, whether the measure has been accepted, partially accepted, or rejected by a user or an organization.

The term “execution result information” refers to a part of feedback information that indicates the actual results of executing a proposed measure, including at least performance indicators, achieved effects, or deviations from expected outcomes.

The term “learning data” refers to data generated by the processor from business information, environmental information, response sentences, and feedback information, which is used to update or improve at least one of the structure of a prompt sentence and conditions supplied to the generative information processing model.

The term “structure of the prompt sentence” refers to an arrangement and composition of elements within a prompt sentence, including ordering, grouping, and emphasis of explanatory text, instruction sentences, and examples provided to the generative AI model.

The term “condition to be given to the generative information processing model” refers to a parameter, setting, or auxiliary input associated with a prompt sentence, such as a role definition, output format specification, or generation constraint that influences how the model produces a response.

The term “external information providing apparatus” refers to a computing system or service, distinct from the server, that supplies environmental information such as market information or competitor information to the processor via a communication network.

The term “market information” refers to environmental information that indicates states or trends of a commercial market, including at least market size, market growth, price indices, and demand indicators.

The term “competitor information” refers to environmental information that indicates states or actions of competing entities, including at least competitor sales data, product releases, pricing strategies, or share of market.

The term “management index” refers to a quantitative or qualitative measure used to evaluate performance or status of an organization, including at least revenue, profit, cost ratios, liquidity indicators, and risk-related indicators.

The term “risk factor” refers to a condition or event that may adversely affect an organization's performance or objectives, including at least market risks, operational risks, financial risks, and compliance risks.

The term “management index input screen” refers to a graphical user interface screen displayed on the terminal, through which a user can input or select management indexes to be used as part of the business information.

The term “risk factor input screen” refers to a graphical user interface screen displayed on the terminal, through which a user can input or select risk factors to be used as part of the business information.

The term “display control program” refers to a software module executed by the processor that controls generation and transmission of user interface data to the terminal, including at least management index input screens and risk factor input screens.

The term “summary information update” refers to processing in which the processor recalculates indicator values and regenerates summary information based on newly obtained or changed business information or environmental information.

The term “dynamic update of the prompt sentence” refers to processing in which the processor modifies contents of a prompt sentence, including explanatory text and instruction sentences, in response to changes in summary information, market information, or competitor information over time.

In one embodiment, a server cooperates with at least one terminal and at least one storage device connected through a communication network to implement the claimed system. The server includes a processor, a main memory, a network interface, and a non-transitory computer-readable medium storing program modules. The terminal includes at least a display, an input device, a communication interface, and a browser or a dedicated client application.

The server executes an operating system such as a server-class operating system, and application software implemented, for example, using a programming language such as Python. The server optionally uses a web application framework such as a generic web framework, a database management system such as a relational database server, and data analysis libraries such as a tabular data processing library and a numerical computation library. The server accesses a generative AI model that can be implemented as a large-scale neural network deployed on an external AI service or on a dedicated inference server.

The terminal executes a browser application such as a generic web browser, or a native application, to display user interfaces and exchange data with the server. The user operates the terminal to input business information, environmental information, and feedback relating to strategy proposal information.

In one configuration, the server uses a relational database management system such as a generic SQL server to implement the storage device. The server stores business information, environmental information, indicator values, response sentences, and feedback information in normalized relational tables. Each table includes primary keys, foreign keys, time stamps, and indexing structures that enable rapid retrieval and correlation across business contexts and historical outcomes. For example, a “business_info” table can store company identifiers, time periods, product categories, and numerical values for sales and costs; an “environment_info” table can store market indicators and competitor metrics; a “decision_log” table can store prompt sentences, strategic decisions, and model outputs; and a “feedback_log” table can store user adoption information and execution result information linked to the “decision_log” entries.

The server uses a numerical computation library (for example, a library capable of optimized linear algebra using vectorized operations) and a data analysis library (for example, a library providing data frame structures, grouping, joining, and statistical functions) to perform preprocessing. The server loads relevant rows from the database into in-memory data frames. The server then executes non-trivial preprocessing, including missing value completion based on time-series interpolation and group-based imputation, outlier detection using statistical thresholds such as z-scores or interquartile ranges, and normalization using scaling functions such as min-max scaling or z-score normalization.

The server applies these preprocessing routines to business information and environmental information in a standardized, algorithmically defined manner. This structured preprocessing reduces noise and numerical instability in subsequent computations. Because the server performs these operations using optimized vectorized routines, execution is substantially faster and more consistent than manual spreadsheet-based manipulations. In particular, the server reduces the number of passes over the data by combining multiple preprocessing tasks (missing value handling, outlier correction, and normalization) in a single pipeline, which reduces memory access and cache misses and thereby improves computational efficiency.

The server generates indicator values as intermediate data structures. For example, the server computes a sales trend indicator by calculating quarter-over-quarter and year-over-year growth rates for each product, using vectorized difference and division operations on time-sorted sales sequences. The server computes a profit margin trend by subtracting normalized cost series from normalized revenue series and analyzing the resulting margin series via moving averages and slope estimation. The server determines a market growth rate by aggregating external market indices and computing weighted growth using predefined weights per region or segment. The server calculates a cancellation rate by dividing the number of terminated contracts or lost customers by the number of active contracts or customers in a given period.

The server stores these indicator values in dedicated structures, such as a “metrics” table, and in memory as arrays and data frames. The server then converts the indicator values into summary information. To do so, the server executes rule-based summarization algorithms that select key metrics based on abnormality scores or thresholds. For example, if the sales trend shows a decline greater than a preconfigured threshold while the market growth rate remains positive, the server marks this condition as “internal underperformance” and includes it in the summary information. These rule-based selections reduce the effective dimensionality of the input to the generative AI model and provide a consistent structure to the prompt sentence.

The server converts the summary information into explanatory text in a natural language. The server employs template-based generation in which indicator values are inserted into grammatically structured sentences. For example, when sales decline continuously for multiple periods, the server generates a sentence such as:

“Overall revenue has decreased for the last three consecutive quarters, while the main market continues to grow at approximately 4 percent per quarter.”

Similarly, when the profit margin declines and cancellation rates increase, the server generates sentences such as: “Gross margin has decreased from 40 percent to 33 percent over the past four quarters, and the customer cancellation rate has risen from 5 percent to 9 percent in the same period.”

The server concatenates such sentences and applies ordering rules that place high-priority risk indicators, such as sharp margin declines or high cancellation rates, earlier in the explanatory text. These ordering rules are defined to optimize the attention of the generative AI model, based on experiments with model behavior and feedback records.

The server generates a prompt sentence by combining the explanatory text with an instruction sentence. In one embodiment, the server uses the following example of a prompt sentence:

“You are a strategic advisor for an organization.

Here is summarized data for the last six quarters:
Overall revenue trend: +3%, +2%, 0%, −2%, −4%, −3%
Main market growth: approximately +4% per quarter over the same period
Gross margin trend: from 38% down to 31% in six quarters
Marketing expenditure: increased by 15% over the last two quarters
Cancellation rate of key clients: increased from 4% to 8%
Recent cost reduction measures: minor reduction in overhead, limited effect

Based on this information, decide whether the organization should take an offensive (‘attack’) or defensive (‘defend’) strategy in the next quarter.
1. Clearly state ‘attack’ or ‘defend’ as your decision.
2. Provide detailed reasons using the data above.
3. Propose three to five concrete actions aligned with your decision, specifying how each action mitigates risk or exploits opportunity.”

In another embodiment, the server uses a more generic prompt sentence:

“Considering the organization's sales data and market trends, support the strategic decision for the next period. Please decide whether the organization should attack or defend, and provide the answer with specific reasons and detailed proposals.”

The server can vary the level of detail and structure of the prompt sentence depending on system configuration and user preferences, but the server consistently includes at least summary information and explicit instructions regarding strategic decision and measure generation.

The server interacts with a generative AI model that is implemented as a deep neural network, such as a transformer-based language model. The generative AI model includes multiple encoder-decoder layers or decoder-only layers with multi-head self-attention mechanisms, positional encodings, and feed-forward networks. The generative AI model receives tokenized representations of the prompt sentence, processes them through a series of attention and feed-forward layers, and outputs probability distributions over tokens that are sampled or greedily selected to generate the response sentence.

The server configures parameters of the generative AI model via an API, such as temperature (controlling randomness), maximum number of tokens (controlling output length), and penalties for repetition. These parameters are stored as part of the conditions given to the generative AI model. The server sets these parameters adaptively based on the complexity of the input summary information and feedback on past outputs. For example, if previous outputs were too generic, the server lowers the temperature and increases a relevance weight for data-specific content by emphasizing indicator values in the prompt sentence.

The generative AI model itself is trained in advance using a combination of unsupervised learning and supervised fine-tuning. In unsupervised learning, the model minimizes a token prediction loss function such as cross-entropy over large-scale corpora of text. During fine-tuning, the model can be trained using instruction-response pairs where the input includes business-like summaries and the output includes strategic decisions and explanations. The server can further adapt prompt usage using in-context learning, where examples of good decisions and explanations are embedded into the prompt sentence.

The server can also manage additional training or adaptation using collected feedback information. In one implementation, the server constructs a dataset from the stored prompt sentences, response sentences, adoption information, and execution result information. The server labels cases where recommended measures led to positive outcomes as “effective” and others as “ineffective.” The server then trains an auxiliary ranking model or a light-weight classifier using a machine learning library such as a generic machine learning framework. This auxiliary model estimates the effectiveness of candidate measures based on indicator values and textual features extracted from the response sentences. The server uses this auxiliary model to re-rank or filter measures output by the generative AI model before transmitting strategy proposal information to the terminal.

The server structures features for such auxiliary models by combining numeric indicator vectors with text embeddings. For example, the server uses a word embedding or sentence embedding algorithm to convert portions of the response sentence into fixed-length vectors, then concatenates these vectors with normalized indicator arrays. The server minimizes a binary cross-entropy loss for effectiveness prediction using gradient descent and updates model weights to better discriminate between historically effective and ineffective measures.

The server, by integrating these models, performs processing that is not a mere automation of human mental evaluation. The server exploits the generative AI model's capability to interpret complex numerical summaries and to generate multiple candidate measures while simultaneously applying rule-based and learned ranking procedures that consider historical outcomes. This combination yields an improved decision pipeline in which the server traverses less candidate space than exhaustive enumeration while achieving higher precision in recommending measures that are empirically effective. Consequently, the server reduces computational overhead and communication load by transmitting fewer but higher-quality measures to the terminal.

The server further optimizes data structures and communication patterns to improve technical performance. For example, the server caches intermediate indicator values and summary information in memory with identifiers keyed by company, period, and scenario to avoid redundant recomputation when similar strategic evaluations are requested. The server compresses data transmitted to the generative AI model by summarizing time series into statistics and carefully curated excerpts, thus reducing network bandwidth usage and latency. Additionally, the server applies incremental update techniques: when new environmental information such as market or competitor information arrives, the server updates only affected indicator values and summary sentences, instead of recomputing the entire dataset from scratch. These optimizations lead to reduced processor load and improved responsiveness of the system, particularly under high-frequency update conditions.

The terminal operates as a thin client. The terminal displays management index input screens and risk factor input screens generated by the server. The terminal also displays strategy proposal information including the strategic decision, explanatory text, and proposed measures. The terminal may render graphical components such as trend charts using client-side libraries, but the main computational tasks remain on the server. This division of labor reduces processing requirements on the terminal and allows consistent behavior across different terminal types, such as personal computers, tablets, and smart phones.

The user interacts with the terminal to input business information and feedback information. However, the user does not manually compose the prompt sentence or aggregate data into summaries. Instead, the server automatically handles these tasks, ensuring consistency in how indicator values are selected and presented. This reduces variability between operators and ensures that the generative AI model receives inputs with consistent structure, which in turn yields more stable outputs.

In another embodiment, the server obtains environmental information directly from external information providing apparatuses via machine-to-machine communication. The server may use standardized data feeds, such as a market data feed or a competitor information API. The server periodically fetches and stores these data streams, updating environmental information tables. The server then continuously or periodically regenerates summary information and prompt sentences, and queries the generative AI model to obtain updated strategic decisions. This configuration allows the system to operate in near real time, adjusting strategic recommendations as market conditions change. The technical effect includes a reduction in stale information and an improvement in the timeliness and relevance of decisions, which cannot be realistically matched by manual updates.

In a further variation, the server supports multiple generative AI models or multiple versions of a model. The server may select a particular model or version based on the size of the input, the complexity of the requested analysis, or performance metrics derived from feedback. The server logs model identifiers and performance statistics, and periodically re-evaluates routing logic to optimize throughput and accuracy. For instance, the server may employ a smaller, faster model for routine cases with low risk and a larger, more accurate model for high-impact strategic evaluations. By adaptively routing requests, the server reduces average response time while maintaining or improving overall decision quality.

The server also defines non-conventional rules for prompt construction and response interpretation that differ from simple template filling. For example, the server controls token budgets by dynamically adjusting the level of detail in historical summaries based on a length forecast function. This function estimates the number of tokens required for a segment of explanatory text and prunes less critical details when the estimated total would exceed a threshold. This non-standard token budget control leads to more stable and predictable generation times and avoids truncation by the generative AI model, thereby improving reliability.

Additionally, the server defines a structured post-processing algorithm for response sentences. The server analyzes headings, bullet indicators, and key phrases in the response, and normalizes them into a structured schema with fields such as “decision,” “rationale factors,” and “proposed actions.” The server associates each proposed action with affected indicators (for example, actions that address declining margin or high cancellation rates) by matching textual references to indicator names or ranges. This structured mapping enables fine-grained evaluation of which actions target which indicators, supporting precise evaluation and feedback-driven optimization.

Because the server systematically organizes data flows—from raw business and environmental information, through optimized preprocessing, structured summarization, prompt sentence generation, generative AI inference, and feedback-based refinement—the system achieves technical advantages in data management, computation efficiency, and communication efficiency. The server reduces redundant computation by reusing intermediate data; the server reduces network traffic by limiting information to compact summaries; the server improves accuracy by integrating historical outcomes into the ranking and refinement of model outputs; and the server improves processing speed by using vectorized operations and incremental updates. These aspects improve the functioning of the computer system itself, beyond mere automation of a human analyst's reasoning.

Multiple implementation variations are possible within the same inventive concept. For example, the server may implement the generative AI model locally using specialized hardware accelerators such as graphical computation units or tensor processing units. Alternatively, the server may rely on an external AI platform exposed via an application programming interface. The preprocessing algorithms may employ alternative techniques such as robust statistics or time-series decomposition instead of or in addition to basic normalization. The auxiliary models for measure ranking may use different architectures, such as gradient boosting machines or shallow neural networks. Regardless of specific design choices, the server executes a coordinated sequence of hardware-level and software-level operations that transform and structure data in a way that meaningfully improves strategic decision support while enhancing the underlying computer technology.

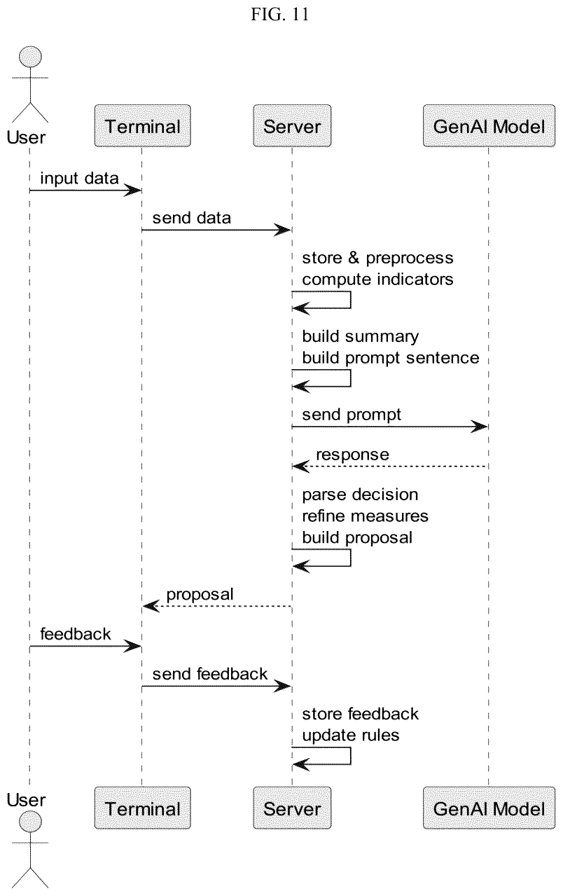

The following describes the processing flow using FIG. 11.

### Step 1:

The user operates the terminal to input business information and environmental information.

The user opens a web application on the terminal and enters data such as sales amounts, costs, management indexes, risk factors, and optionally uploads files containing historical data. The user may also select time ranges, product categories, and regions from dropdown menus.

Input: raw business information and environmental information entered by the user (form fields, uploaded files, selection parameters).

Output: structured request data on the terminal (for example, JSON objects or form-encoded key-value pairs) ready to be sent to the server.

### Step 2:

The terminal transmits the structured request data to the server.

The terminal executes client-side scripts to validate required fields and data formats, and then sends an HTTPS request containing the structured data to an endpoint exposed by the server. The terminal may include authentication tokens and metadata such as user ID and session ID.

Input: structured request data in memory on the terminal.

Output: an HTTPS request containing the structured data, transmitted over the network to the server.

### Step 3:

The server receives the HTTPS request and stores the raw data in the storage device.

The server parses the request body, verifies authentication and authorization, and converts the payload into internal data structures such as dictionaries or data frames. The server constructs SQL INSERT statements or uses an object-relational mapper to write the received business information and environmental information into relational tables in the storage device. The server also stores timestamps and identifiers for later retrieval.

Input: HTTPS request containing structured business and environmental information.

Output: normalized records written to database tables (for example, business_info, environment_info, request_log) in the storage device.

### Step 4:

The server retrieves relevant stored data for the current strategic evaluation.

The server analyzes the request context (e.g., company identifier, time period, target product) and generates SQL SELECT queries to fetch corresponding records from the storage device. The server uses a database client to execute these queries and converts query results into in-memory tabular structures such as data frames.

Input: identifiers and parameters from the request_log table and related keys.

Output: in-memory datasets containing business information and environmental information for the requested context.

### Step 5:

The server performs preprocessing on the retrieved datasets using numerical computation and data analysis programs.

The server uses a numerical library and a tabular data processing library to handle missing values (for example, by interpolation or group-based mean imputation), detect and remove outliers (for example, using z-scores or interquartile range thresholds), and normalize numeric columns (for example, applying min-max scaling or z-score normalization). The server aligns time-series data by merging tables on time keys and filling gaps as needed.

Input: raw in-memory datasets retrieved from the storage device (with possible missing values, inconsistencies, and mixed scales).

Output: cleaned and normalized data frames and arrays, with consistent time alignment and reduced noise, ready for indicator computation.

### Step 6:

The server calculates indicator values representing trends and conditions relevant to strategy.

The server computes sales trends by calculating differences and growth rates across consecutive periods, computes profit margin trends by subtracting cost series from revenue series and analyzing their change over time, calculates market growth rates by aggregating external indices, and computes cancellation rates by dividing termination counts by active contract counts. The server may also compute composite scores (for example, a risk score combining multiple indicators) using weighted sums or machine learning models.

Input: cleaned and normalized data frames and arrays from Step 5.

Output: a set of indicator values (for example, sales_trend, margin_trend, market_growth_rate, cancellation_rate, risk_score) stored in memory and optionally in a metrics table.

### Step 7:

The server generates summary information and explanatory text from the indicator values.

The server selects key indicators based on thresholds or ranking (for example, focusing on indicators with deviations above a set level). The server then applies template-based rules to convert each selected indicator into a natural-language sentence. The server orders these sentences according to predefined priority rules (for example, margin deterioration before sales trend) and concatenates them into a coherent explanatory text describing the current situation.

Input: indicator values and selection rules stored in the server.

Output: structured summary information and a natural-language explanatory text describing those indicators.

### Step 8:

The server constructs a prompt sentence to be submitted to the generative AI model.

The server loads a prompt template that includes instruction sentences, and injects the explanatory text and indicator values into designated positions. The server adds explicit instructions requesting a strategic decision (“attack” or “defend”) and a specified number of concrete measures with reasoning. The server may also add context such as organization type or risk tolerance.

Input: explanatory text, indicator values, and prompt template definitions.

Output: a complete prompt sentence (or a set of messages) formatted as natural-language text to be used as input for the generative AI model.

### Step 9:

The server transmits the prompt sentence to the generative AI model and obtains a response sentence.

The server uses an API client or local inference engine to encode the prompt sentence into tokens and send it to a transformer-based generative AI model. The model processes the tokens through multiple attention and feed-forward layers and outputs token probabilities step by step; the server decodes the token sequence into a natural-language response sentence. When using an external model, the server sends an HTTPS request with the prompt and receives an HTTP response containing the generated text.

Input: prompt sentence and model configuration parameters (for example, temperature, maximum tokens).

Output: response sentence including at least a strategic decision (“attack” or “defend”), reasons, and proposed measures.

### Step 10:

The server parses the response sentence and extracts structured decision data.

The server scans the response sentence for decision keywords and phrases to determine whether the strategy is “attack” or “defend.” The server splits the text into sections (for example, decision, reasons, actions) based on headings or markers, and applies natural-language parsing or regex rules to isolate individual measures. The server then structures this information into fields such as decision_label, reason_list, and measure_list.

Input: raw natural-language response sentence from the generative AI model.

Output: structured decision data including a strategic decision label, reasons, and a list of proposed measures.

### Step 11:

The server refines defensive measures using historical information stored in the storage device.

When the extracted strategic decision is “defend,” the server queries the storage device for past decision records with similar indicator patterns (for example, similar sales decline and margin trend) using similarity measures or range filters. The server retrieves past measures and their execution results, identifies which measures were effective based on execution result information, and adjusts the current measure_list by prioritizing historically effective measures, discarding historically ineffective ones, or adding newly suggested measures derived from combinations.

Input: decision_label=“defend,” current measure_list, and historical decision_log and feedback_log records.

Output: refined measure_list and one or more protection measures that are aligned with current conditions and past effectiveness data.

### Step 12:

The server composes strategy proposal information to be transmitted to the terminal.

The server combines the strategic decision label, the explanatory text, and the refined measures (either protection measures or offensive measures) into a structured response object. The server may include additional metadata, such as affected indicators, estimated impact scores, or confidence levels. The server serializes this object into a format suitable for network transmission, such as JSON.

Input: structured decision data from Step 10, refined measures from Step 11, and explanatory text from Step 7.

Output: a strategy proposal information object ready to be sent to the terminal.

### Step 13:

The server sends the strategy proposal information to the terminal.

The server returns an HTTPS response to the terminal's request endpoint, embedding the serialized strategy proposal information in the response body. The server may also set cache headers or tracking identifiers for logging and future reference.

Input: strategy proposal information object in memory on the server.

Output: HTTPS response containing the strategy proposal information, transmitted to the terminal.

### Step 14:

The terminal receives and displays the strategy proposal information to the user.

The terminal parses the received data object, interprets fields such as decision_label, reasons, and measures, and renders them on a user interface. The terminal displays the decision (“attack” or “defend”) prominently, presents reasons as explanatory text, and lists proposed measures in a structured manner (for example, bullet points with labels and descriptions). The terminal may also render supporting charts using numeric values received from the server.

Input: HTTPS response containing the strategy proposal information.

Output: visual representation of the strategic decision and proposed measures on the terminal display.

### Step 15:

The user reviews the displayed information and inputs feedback via the terminal.

The user evaluates each proposed measure, selects options to adopt, partially adopt, or reject measures, and optionally enters comments and observed or expected outcomes. The user then submits the feedback through the interface.

Input: displayed strategy proposal information and user judgments or comments.

Output: structured feedback information generated on the terminal (for example, adoption flags, comments, outcome values).

### Step 16:

The terminal transmits the feedback information to the server.

The terminal packages the user's feedback into a structured payload and sends it to a dedicated feedback endpoint on the server using HTTPS. The payload includes references to the original decision record and measures so the server can link feedback to prior decisions.

Input: structured feedback information on the terminal.

Output: an HTTPS request containing feedback information transmitted to the server.

### Step 17:

The server stores the feedback information and links it with the corresponding decision and measures.

The server parses the received feedback payload, validates references to decision and measure identifiers, and inserts or updates records in the feedback_log table in the storage device. The server associates each feedback entry with the corresponding decision_log entry and with indicator values that were used for that decision.

Input: feedback information received from the terminal, and existing decision_log and metrics records.

Output: updated database state in which feedback information is persistently stored and linked to past decisions and measures.

### Step 18:

The server generates learning data to improve future prompt sentence structures and model conditions.

The server periodically retrieves accumulated decision_log, feedback_log, and metrics data from the storage device, and constructs training samples that capture relationships between prompt structures, indicator patterns, model outputs, and execution outcomes. The server analyzes which prompts and conditions (for example, parameter settings, ordering of information) resulted in effective measures, and updates internal rules or auxiliary models that control prompt sentence configuration and parameter selection.

Input: historical prompt sentences, model responses, indicator values, and feedback information from the storage device.

Output: updated rules, learned parameters, or auxiliary model weights that define improved prompt sentence structures and conditions for subsequent interactions with the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented decision support systems for production management typically rely on static rule sets, manually defined thresholds, or simple statistical models. These systems are often implemented as straightforward data collection and dashboard tools that merely visualize key performance indicators without performing context-aware strategy generation. As a result, such systems suffer from several technical limitations.

First, the conventional systems do not efficiently utilize heterogeneous time-series data obtained from multiple observation devices, such as sensors and controllers distributed along production processes. The raw data streams are frequently noisy, incomplete, and misaligned in time, and traditional processing pipelines are not designed to robustly perform missing-value completion, noise reduction, normalization, and feature extraction in an integrated manner suitable for machine learning models. This leads to suboptimal data representations inside the computer system, which in turn degrade the accuracy and reliability of automatic analysis.

Second, existing decision support tools that incorporate machine learning generally treat model input as fixed-format numerical vectors and do not dynamically construct prompt sentences or other natural-language representations that explicitly embed current operation indices and quality indices. As a result, generative AI models cannot fully exploit rich contextual information about the current production state and management requirements, which limits the quality and controllability of generated recommendations. In particular, conventional architectures lack a mechanism in which the processor systematically generates and updates prompt sentences that combine structured numerical features with natural-language descriptions of production conditions.

Third, known systems do not provide an integrated computer-implemented mechanism to couple generative AI outputs with structured, machine-readable strategy objects usable for downstream automation. Generated natural-language recommendations, if any, are typically presented as free text, and there is no consistent procedure in the processor for parsing the text, classifying actions into “attack enhancement” (aggressive improvement) or “defense maintenance” (risk control), and converting the results into structured data including process identifiers, action types, and priorities. This deficiency reduces the ability of the computer system to automatically track, compare, and refine strategies across iterations.

Fourth, conventional decision support systems do not technically integrate learned experience from past production history, failure events, and countermeasure outcomes with the generative AI workflow. Historical information is often stored in separate databases and accessed manually by human experts. The computer system does not automatically retrieve similar cases, summarize past countermeasures, and feed such summaries back into the generative AI model as additional prompt sentences, resulting in an inability of the system to computationally leverage prior knowledge to generate more robust defense strategies.

Fifth, current systems offer limited support for dynamic control of generative AI behavior based on management-level inputs and external environment information. There is no standardized architecture in which a processor receives management indices, constraint conditions, and target processes from an information display device, and programmatically binds these constraints to prompt sentences that condition the generative AI model. Likewise, external environment information such as demand information and competition information is not systematically associated with internal time-series information and injected into the model input in a periodic or event-driven manner. Consequently, the generated strategies do not adapt efficiently to changing business conditions or user preferences.

In summary, there is a need for an improved computer-implemented system that technically enhances (i) the preprocessing and feature extraction of production-related time-series information, (ii) the construction and updating of prompt sentences for a generative AI model, (iii) the conversion of generative AI outputs into structured strategy data, (iv) the automatic integration of historical experience into defense strategies, and (v) the dynamic control of generative AI behavior based on management inputs and external environment information. Such improvements would result in more accurate, traceable, and adaptable strategy generation within the computer system itself, thereby improving the functioning of the computer as a decision-support machine rather than merely automating a mental process.

The specific processing by the specific processing unit 290 of the data processing device 12 in Application Example 1 is realized by the following means.

The present invention provides a server comprising a processor and a memory, the processor being configured to acquire time-series information related to production activities from observation devices and store the acquired time-series information in the memory; perform missing-value completion, noise reduction, normalization, and feature extraction on the time-series information to generate structured information representing states of respective production processes; calculate numerical information including operation indices and quality indices for the respective production processes based on the structured information and generate a prompt sentence by embedding the numerical information into a natural-language format; provide the prompt sentence and the structured information as input to a generative AI model and cause the generative AI model to execute computation to determine, for each production process, at least one of an attack enhancement target and a defense maintenance target; analyze a natural-language expression output from the generative AI model, extract recommended content indicating, for each production process, an attack enhancement action or a defense maintenance action, and generate structured data including, for each production process, a process identifier, an action type, and a priority; retrieve, from an information storage unit storing past production history information, failure information, and countermeasure information, a similar case corresponding to a current production state, summarize a candidate management defense measure based on the similar case, generate an additional prompt sentence including a result of the summarization, and provide the additional prompt sentence to the generative AI model to cause the generative AI model to generate a defense strategy including a risk-reduction measure; integrate the attack enhancement action and the defense strategy, associate the integrated result with management indices and production indices, and output strategy proposal information to an external device; and receive, from the external device, approval information or modification request information from a user regarding the strategy proposal information, store the approval information or the modification request information in association with the strategy proposal information, and update at least one of the generative AI model and the feature extraction processing based on a result of the storing. This enables the computer system to internally transform heterogeneous production data into enriched prompt sentences and structured strategy objects, to iteratively refine attack and defense strategies using both current sensor information and historical cases, and to dynamically adapt generative AI behavior to management constraints and external environment changes, thereby improving the technical performance, adaptability, and reliability of computer-implemented strategy generation for production management.

The term “time-series information” refers to information comprising a plurality of data values each associated with a time indicator and representing changes of a state or condition over time.

The term “production activities” refers to sequences of operations or processes performed in a manufacturing or processing environment for producing goods or services.

The term “observation devices” refers to hardware devices configured to measure or capture physical or operational conditions in a production environment, including, for example, sensors, controllers, cameras, and data acquisition units.

The term “memory” refers to a hardware storage component, such as a volatile or non-volatile storage medium, configured to store data, instructions, or models for access by a processor.

The term “missing-value completion” refers to processing that estimates or fills in data values for time points or items where measurements are absent, based on predetermined rules or statistical or machine learning methods.

The term “noise reduction” refers to processing that removes or attenuates undesired variations or outliers in data so as to improve data quality for subsequent analysis.

The term “normalization” refers to processing that transforms numerical data into a standardized scale or range to facilitate comparison or computation.

The term “feature extraction” refers to processing that derives higher-level numerical or categorical descriptors from raw or preprocessed data for use in analysis or machine learning.

The term “structured information” refers to information organized in a defined schema or format, such as tables, records, or tensors, enabling systematic access and computation by a processor.

The term “production processes” refers to individual stages or steps within a production line or production system that perform specific operations contributing to the manufacture of a product.

The term “operation indices” refers to numerical indicators representing operational performance of a production process, such as utilization, throughput, processing time, or downtime.

The term “quality indices” refers to numerical indicators representing quality performance of a production process, such as defect rate, yield, or rework frequency.

The term “prompt sentence” refers to a sequence of natural-language expressions, optionally including embedded numerical or symbolic information, provided as input to a generative AI model to condition or guide its output.

The term “generative AI model” refers to a machine learning model configured to generate output information, such as text, symbols, or other data representations, based on input data and learned parameters.

The term “attack enhancement target” refers to a production process or aspect identified by the system as a candidate for aggressive improvement, expansion, or performance enhancement.

The term “defense maintenance target” refers to a production process or aspect identified by the system as a candidate for risk control, stability maintenance, or protection against degradation.

The term “natural-language expression” refers to text or other representation composed in a human language, such as sentences or paragraphs, output by a generative AI model.

The term “recommended content” refers to information in a natural-language expression that specifies suggested actions, adjustments, or strategies to be taken with respect to production processes.

The term “structured data” refers to data organized according to a predefined structure, including identifiable fields such as identifiers, categories, and numerical values, suitable for programmatic processing.

The term “process identifier” refers to a data element that uniquely or distinctively represents a particular production process within a production system.

The term “action type” refers to a data element indicating a category or classification of an action, including categories such as attack enhancement action or defense maintenance action.

The term “priority” refers to a data element indicating a relative importance, urgency, or execution order assigned to a recommended action.

The term “information storage unit” refers to a data storage subsystem, which may be implemented by one or more databases or file systems, configured to store production history information, failure information, countermeasure information, and related data.

The term “production history information” refers to stored information representing past states, performance metrics, and operational conditions of production processes.

The term “failure information” refers to stored information representing occurrences of malfunctions, breakdowns, or abnormal events in production processes or equipment.

The term “countermeasure information” refers to stored information representing actions taken in response to failures or risks and the outcomes of those actions.

The term “similar case” refers to a set of historical information identified by the system as having characteristics that correspond to or resemble a current production state according to predetermined similarity criteria.

The term “candidate management defense measure” refers to a potential action or set of actions derived from similar cases and intended to reduce risk or enhance stability in a production or management context.

The term “additional prompt sentence” refers to a prompt sentence that has been augmented or newly generated to include information derived from historical cases, summaries, or user inputs to further condition a generative AI model.

The term “defense strategy” refers to a set of coordinated actions or policies generated by the system and aimed at reducing risk, preventing failures, or maintaining stable operation of production processes.

The term “risk-reduction measure” refers to a specific action within a defense strategy that is intended to lower the probability or impact of undesirable events.

The term “strategy proposal information” refers to information that aggregates recommended attack enhancement actions and defense strategies and associates them with management and production indices for presentation or further processing.

The term “external device” refers to an information processing or display device, distinct from the server, configured to receive strategy proposal information and provide user input such as approvals or modification requests.

The term “approval information” refers to user-provided information indicating acceptance or confirmation of one or more recommended actions or strategies.

The term “modification request information” refers to user-provided information indicating a change, refinement, or rejection with respect to one or more recommended actions or strategies.

The term “management indices” refers to numerical or categorical indicators used by a management or administration layer to evaluate business performance, such as cost, profit, delivery time, or resource utilization.

The term “production indices” refers to numerical or categorical indicators used to evaluate performance of production processes, such as output volume, cycle time, and equipment utilization.

The term “information display device” refers to a user interface apparatus, such as a terminal, workstation, or display-equipped computing device, configured to present information to a management layer or administration layer and receive input therefrom.

The term “management layer” refers to a group of users or a functional level in an organization responsible for planning, supervising, and making decisions regarding business or production operations.

The term “administration layer” refers to a group of users or a functional level in an organization responsible for operational management, control, or supervision of production or related activities.

The term “constraint conditions” refers to limits or requirements, such as budget constraints, capacity limits, or policy rules, specified by a user to restrict or shape generated strategies.

The term “target production processes” refers to selected production processes designated by a user or system for focused analysis or strategy generation.

The term “demand information” refers to information representing current or predicted demand for products or services, including order volumes, forecasts, and market trends.

The term “competition information” refers to information representing conditions related to competitors, such as competitor capacity, prices, product availability, or market share.

The term “external information” refers to information obtained from sources outside the production system, including demand information and competition information, that affects production or strategy decisions.

The term “periodically or event-drivenly” refers to execution according to a schedule with regular time intervals or in response to occurrence of specified events or conditions.

In one embodiment, a server cooperates with one or more terminals and users to implement a production strategy support system that performs time-series data acquisition, preprocessing, feature extraction, prompt construction, generative AI inference, strategy structuring, and feedback-based updating. The server executes program modules stored in a memory and runs on general-purpose computing hardware such as a multi-core processor with an operating system. The server may utilize hardware accelerators such as graphics processing units for neural network computation. The server communicates with observation devices deployed in a factory environment and with terminals used by management and operation personnel over a communication network.

The server acquires time-series information from observation devices associated with production activities. The server uses industrial controllers, sensor nodes, and embedded computing boards to collect measurements such as temperature, humidity, vibration, motor current, machine on/off status, error codes, and production counts. The server receives the measurements over wired or wireless links using communication protocols such as Transmission Control Protocol/Internet Protocol, message-queuing protocols, or hypertext transfer protocols. The server stores the acquired time-series information in a time-series database or structured log files within the memory, associating each measurement with a timestamp, a device identifier, and a process identifier.

The server performs missing-value completion on the stored time-series information. The server applies numerical interpolation techniques such as linear interpolation or spline interpolation to fill gaps in time-series segments. The server may also apply forward-fill rules where the last known value for a sensor is propagated to the next missing time point within a specified time window, or may insert a default nominal value for certain discrete states. The server selects a completion method per signal type based on configuration tables stored in the memory, thereby generating continuous time-series suitable for downstream analysis.

The server performs noise reduction on the time-series information. The server applies digital filtering algorithms such as moving-average filters, median filters, and low-pass filters to attenuate high-frequency noise and to remove outlier values that exceed a configured threshold in terms of standard deviations from a local mean. The server executes these filters in vectorized form using numerical computation libraries to reduce processing time. The server records filtered values and flags indicating which data points were modified, enabling traceability for later inspection.

The server performs normalization of numerical values across different sensors and processes. The server computes statistics such as minimum, maximum, mean, and standard deviation for each type of measurement over a configurable reference period. The server then transforms raw values into normalized scores, such as min-max scaled values in a [0,1] range or z-scores. This normalization enables the generative AI model to process inputs with comparable scales, improving numerical stability of the neural network computations and reducing training and inference errors.

The server performs feature extraction on the normalized time-series information to generate structured information representing respective production processes. The server aggregates values into fixed-duration windows, such as 10-minute or 1-hour windows, for each process identifier. For each window, the server computes statistical features such as mean, median, maximum, minimum, variance, and higher-order moments. The server also computes domain-specific features such as machine utilization ratios, average cycle times, mean time between failures, and defect rates per window. The server transforms categorical identifiers, such as machine type or error category, into numerical representations using one-hot encodings or learned embeddings. The server organizes these features into structured data objects, for example, matrices or tensors of shape (number_of_processes, number_of_features), stored in the memory as structured information.

The server calculates operation indices and quality indices for each production process based on the structured information. The server defines operation indices including, for example, throughput, utilization, average processing time, and machine downtime. The server defines quality indices including, for example, defect rate, rework rate, and scrap ratio. The server computes these indices using formulae that combine the extracted features, such as dividing the number of completed units by available machine time to obtain throughput per hour. The server stores the indices together with process identifiers and time window identifiers as index records.

The server generates a prompt sentence by embedding the calculated indices into a natural-language format. The server maintains a text template that includes placeholders for process names or identifiers, utilization ratios, defect rates, and other indices. The server replaces the placeholders with formatted numeric values and textual descriptors. For example, the server generates a prompt sentence such as: “The current production line shows 92 percent utilization at the assembly process, 98 percent utilization at the packaging process, and 65 percent utilization at the painting process, with an overall defect rate of 2.5 percent and unplanned downtime of 1.2 hours per day at the packaging process. Analyze this situation and propose which processes to attack and which processes to defend to maximize efficiency and minimize risk.”

The server may generate other prompt sentences that include defensive considerations. For example, the server generates a prompt sentence such as: “Using the current sensor readings and the following past incidents and countermeasures, generate management defense measures that minimize the probability of unplanned downtime over the next 30 days while keeping total output at or above 95 percent of the current level. Output concrete actions per process step.”

The server provides the prompt sentence and the structured information as input to a generative AI model. The server loads a neural network model from the memory into main memory and, optionally, into accelerator memory. In one embodiment, the generative AI model has an encoder-decoder architecture based on a transformer neural network. The server encodes structured features as vectors and passes them through an encoder network comprising multiple layers of self-attention units and feed-forward layers. The server converts the prompt sentence into token sequences and embeds tokens into vectors using pre-trained token embeddings. The server concatenates or otherwise fuses the encoded structured features and the token embeddings, such as by cross-attention layers where the prompt tokens attend to the feature vectors.

The server executes forward propagation through the neural network. The server performs matrix multiplications, vector additions, non-linear activation functions such as rectified linear units or Gaussian error linear units, and attention mechanisms for each layer. The server computes output token probability distributions using a softmax function at each decoding time step. The server samples or selects tokens based on these probability distributions to generate a natural-language expression comprising one or more sentences. The server may generate both free-form text and auxiliary numerical scores, such as risk scores or priority scores, by adding additional output heads to the neural network that compute regression or classification outputs from intermediate representations.

The server configures the generative AI model using training procedures executed in an offline training phase. The server trains the model using supervised learning and, optionally, reinforcement learning from human feedback. The server defines a loss function that combines language modeling loss, classification loss for attack or defense labels, and regression loss for risk scores. The server calculates gradients of the loss with respect to model parameters using backpropagation and updates the parameters using optimization algorithms such as stochastic gradient descent, adaptive moment estimation, or related methods. The server may also perform data augmentation for training by perturbing input indices within realistic ranges, rephrasing prompt sentences, and sampling sub-sets of historical cases, thereby improving robustness to noisy or incomplete inputs. By optimizing these parameters, the server improves accuracy and stability of the strategy outputs.

The server analyzes the natural-language expression output by the generative AI model to generate structured data usable by other modules. The server applies text parsing and classification routines that identify action phrases, referenced process identifiers, and action categories. The server uses pattern-matching rules and, optionally, an auxiliary classifier network that operates on token embeddings to categorize each recommended action as an attack enhancement action or a defense maintenance action. The server then assembles structured data objects that include fields such as a process identifier, an action type (attack or defense), a priority score, and an expected effect description. The server stores these structured data objects in a database, enabling downstream modules to query and compare recommendations across time.

The server retrieves past production history information, failure information, and countermeasure information from an information storage unit to integrate learned experience into defense strategies. The server queries structured databases using similarity search criteria based on process type, measured indices, and failure codes. The server computes similarity scores between a current window of structured features and historical feature vectors using distance metrics such as cosine similarity or Euclidean distance. The server selects a set of similar cases whose similarity scores exceed a threshold or rank among the top candidates. The server summarizes these cases by extracting key information such as failure cause, applied countermeasures, and observed outcomes.

The server generates an additional prompt sentence that incorporates these summaries. For example, the server generates a prompt sentence such as:

“Past similar incidents include conveyor jams in the packaging process resolved by adding sensors and adjusting conveyor speed, and overheating in the heat treatment process resolved by lowering target temperature and increasing inspection frequency. Given these past incidents and the current state, propose defense measures that minimize unplanned downtime for the packaging and heat treatment processes.”

The server provides the additional prompt sentence, together with updated structured information, to the generative AI model. The server thereby causes the model to produce a defense strategy that explicitly considers historical cases and candidate management defense measures, leading to risk-reduction measures that are consistent with past successes. This integration of structured similarity search and prompt conditioning produces a technical effect of improved recommendation relevance and reduced probability of repeating ineffective measures.

The server integrates attack enhancement actions and defense strategies into strategy proposal information. The server associates each action with relevant management indices and production indices, such as estimated throughput increase, estimated downtime reduction, cost impact, and resource utilization. The server may compute these estimates using analytical models or regression models trained on past data. The server packages the aggregated strategies into response messages and transmits them to terminals.

The terminal receives strategy proposal information from the server and presents it to a user. The terminal may be implemented as a workstation, a portable terminal, or a mobile device. The terminal executes a client application or web browser that parses structured data received from the server. The terminal renders tables, charts, and textual summaries that distinguish attack enhancement actions and defense maintenance actions using different visual markers. The terminal enables the user to sort and filter actions by process, priority, or expected effect, and to inspect the underlying indices and past cases related to each recommendation.

The user interacts with the terminal to provide approval information or modification request information. The user may approve certain actions, reject others, or specify constraints such as budget limits or scheduling restrictions. The user may also input additional natural-language instructions to refine the model behavior. For example, the user may enter a prompt sentence such as: “Focus the attack strategy on reducing lead time for product A without increasing overtime costs, and avoid recommending investments in new equipment this quarter.”

The terminal transmits these user inputs to the server as structured feedback messages.

The server receives approval and modification request information and stores the feedback in association with the corresponding strategy proposal information. The server records which actions were accepted or rejected and the reasons provided by the user, if any. The server uses this feedback to update at least one of the generative AI model and the feature extraction process. For example, the server may retrain parts of the model to reduce the probability of recommending actions that are repeatedly rejected under similar conditions. The server may modify the prompt construction rules to include relevant constraint conditions explicitly in future prompt sentences. By incorporating user feedback directly into the computational pipeline, the server improves the accuracy and alignment of strategy proposals over time.

The server also receives updated time-series information after recommended actions have been implemented in the factory. The server compares pre-action and post-action indices, computes performance differences, and labels strategies as effective or ineffective. The server then uses these labels as supervision for further model training, thereby closing the loop between model recommendations and actual production outcomes. This iterative updating improves prediction accuracy and reduces error rates in subsequent strategy generations.

The server, by integrating intensive preprocessing, structured feature extraction, prompt sentence generation, generative AI inference, and structured strategy parsing, achieves technical improvements over conventional systems. The integrated pipeline reduces the volume of raw data that must be transferred and stored by condensing noisy, high-frequency measurements into compact, informative feature vectors and indices. This reduces communication load and storage requirements. The use of normalized, aligned, and feature-extracted representations improves numerical stability and convergence of neural network training, leading to faster inference and improved accuracy. The explicit conversion of generative outputs into structured data enables automated comparisons and efficient database operations, enhancing data management within the computer system.

The server improves computer technology by providing a non-conventional, non-generic architecture for combining numerical feature tensors with natural-language prompt sentences in a unified neural network pipeline. Conventional systems typically feed either purely numerical vectors to predictive models or purely textual prompts to text-generating models. In contrast, the server fuses structured production features and natural-language descriptions through specific encoder and attention mechanisms, enabling the model to condition its output on both precise quantitative indices and contextual qualitative information. This hybrid conditioning reduces model hallucination, increases robustness to missing or noisy inputs, and yields more consistent outputs, thereby improving overall computational reliability.

The server applies algorithmic rules and non-traditional processing sequences that differ from manual human reasoning or simple rule-based automation. Human decision-makers generally inspect dashboards and apply heuristics without systematically computing similarity metrics over high-dimensional feature space or without embedding past incident summaries into machine-readable prompt templates. The server, however, systematically computes such metrics, performs vectorized distance calculations, and constructs composite prompts that encode both current and historical contexts. This programmable flow, coupled with iterative learning and feedback loops, produces repeatable, machine-executable strategies that would be difficult to replicate manually at similar speed and scale.

The server can be implemented in multiple alternative embodiments. In one variation, the generative AI model is a transformer-based text generation model with additional numeric input channels, and the prompt sentences are primarily textual. In another variation, the model includes both a recurrent neural network for time-series encoding and a transformer decoder for text generation. In still another variation, the model is implemented as a mixture-of-experts network where different expert subnetworks handle different classes of production processes, and a gating network selects or combines expert outputs based on high-level indices. The server may also use different loss functions, such as multi-task losses that combine sequence generation rewards with penalties on misclassification of attack versus defense targets.

The server can vary the feature extraction methods as well. In one embodiment, the server employs frequency-domain features obtained by Fourier transforms or wavelet transforms to detect periodic anomalies in machine vibrations. In another embodiment, the server computes auto-correlation and cross-correlation features between sensors to capture interactions between processes. These variations further increase the sensitivity and specificity of anomaly detection and strategy generation, contributing to reduced false positives and false negatives in recommended actions.

The system thus provides concrete, technical improvements in how production-related information is processed and how strategy recommendations are generated, structured, and refined within a computer system. The server improves the speed of strategy generation by automating data preparation, analysis, and textual explanation in an integrated pipeline; improves accuracy and stability through advanced preprocessing, feature extraction, and model training; reduces communication and storage burdens through compact representations; and enhances the ability of the system to adapt dynamically to changing data and user feedback.

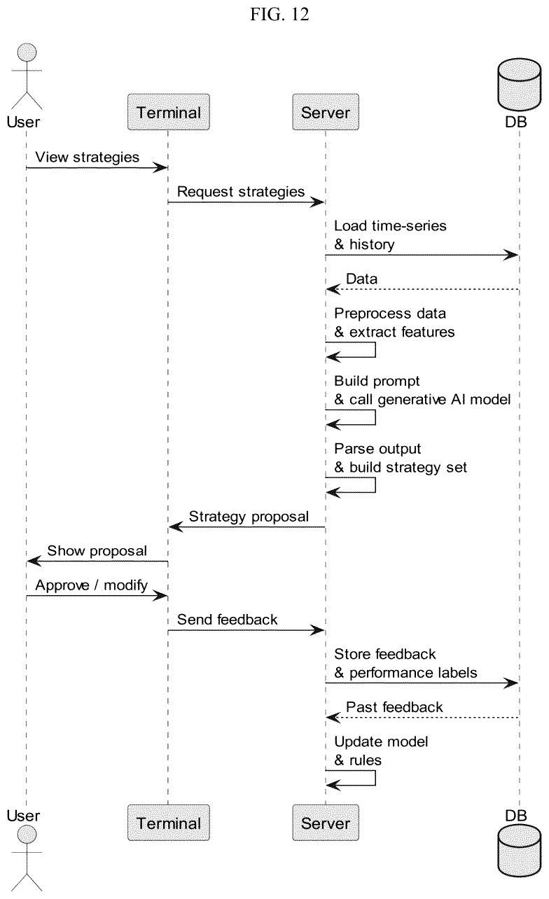

The following describes the processing flow using FIG. 12.

### Step 1:

The server acquires raw time-series information from observation devices in the production environment.

The server receives, as input, sensor readings such as temperature, humidity, vibration, machine status flags, error codes, and production counts, each associated with a timestamp and a device identifier.

The server establishes network connections to embedded controllers and sensor nodes and reads incoming data packets over wired or wireless communication links.

The server parses the packets, validates checksums, converts raw bytes into numerical values, and attaches metadata such as process identifiers.

The server stores, as output, raw time-series records in a storage unit, where each record includes at least a timestamp, a device identifier, a process identifier, a measurement type, and a measurement value.

### Step 2:

The server performs missing-value completion on the stored raw time-series information.

The server receives, as input, raw time-series records for each measurement type and process identifier over a predefined time horizon.

The server detects time gaps by comparing consecutive timestamps and identifies positions where measurements are missing relative to an expected sampling interval.

The server applies numerical interpolation (for example, linear interpolation) to continuous signals and applies forward-fill or default substitution rules to discrete status signals to estimate missing values.

The server outputs completed time-series records in which missing positions are filled with estimated values and flags indicating which data points are original and which are imputed.

### Step 3:

The server performs noise reduction on the completed time-series information.

The server receives, as input, completed time-series records including original and imputed values.

The server applies digital filters, such as moving-average filters or median filters, by computing windowed statistics over sliding windows for each signal; for example, the server replaces each value with the average or median of neighboring values within a specified window size.

The server identifies outlier values by comparing each value to a local mean and standard deviation, and the server clips or replaces values that exceed a configured threshold.

The server outputs denoised time-series records that preserve trend and level information while reducing high-frequency noise and outliers.

### Step 4:

The server performs normalization of the denoised time-series information.

The server receives, as input, denoised time-series records for each measurement type.

The server computes normalization parameters such as minimum, maximum, mean, and standard deviation over a training or reference period.

The server transforms each raw value into a normalized value by applying a selected normalization function, for example, min-max scaling or z-score transformation, so that values for different sensors become comparable in magnitude.

The server outputs normalized time-series records with associated normalization parameters, making the data suitable for stable numerical processing in downstream neural network computations.

### Step 5:

The server performs feature extraction and windowing to generate structured information representing production processes.

The server receives, as input, normalized time-series records, along with process identifiers and timestamps.

The server divides the time-axis into fixed-duration windows, such as 10-minute or 1-hour intervals, for each process identifier.

The server computes, for each window, statistical features including mean, median, maximum, minimum, variance, and trend indicators; the server also computes domain-specific features such as throughput per window, utilization ratio, mean time between failures, and defect rate.

The server encodes categorical attributes such as machine type or error category into numerical vectors using one-hot encoding or embedding tables.

The server outputs structured information in the form of feature vectors or tensors for each process and time window, ready for use as input to a generative AI model.

### Step 6:

The server calculates operation indices and quality indices from the feature vectors.

The server receives, as input, structured feature vectors associated with process identifiers.

The server computes operation indices such as throughput, utilization, average processing time, and downtime by applying arithmetic operations and ratios to relevant features (for example, throughput equals completed units divided by available time).

The server computes quality indices such as defect rate, rework rate, and scrap ratio by dividing counts of non-conforming units by total units produced.

The server outputs index records that associate each process and time window with a set of operation indices and quality indices.

### Step 7:

The server generates a prompt sentence that embeds the calculated indices into a natural-language format.

The server receives, as input, index records for relevant processes and time windows.

The server selects a text template that includes placeholders for process names or identifiers, utilization values, defect rates, and downtime metrics.

The server converts numeric indices into human-readable strings (for example, “92 percent utilization” or “defect rate of 2.5 percent”) and substitutes these strings into the placeholders of the template.

The server generates, as output, a prompt sentence such as: “The current production line shows 92 percent utilization at the assembly process, 98 percent utilization at the packaging process, and 65 percent utilization at the painting process, with an overall defect rate of 2.5 percent and unplanned downtime of 1.2 hours per day at the packaging process. Analyze this situation and propose which processes to attack and which processes to defend to maximize efficiency and minimize risk.”

### Step 8:

The server augments the prompt sentence with management constraints or focus conditions when available.

The server receives, as input, management indices, constraint conditions, and target production processes supplied by a user through a terminal.

The terminal sends text such as “Focus the attack strategy on reducing lead time for product A without increasing overtime costs” or selection inputs specifying target processes and budget limits.

The server parses these inputs, extracts key constraints (for example, cost ceilings, excluded processes), and appends or integrates them into the prompt sentence as additional clauses.

The server outputs an augmented prompt sentence that conditions the generative AI model to produce strategies consistent with management requirements.

### Step 9:

The server retrieves historical cases and constructs an additional prompt sentence for defense strategies.

The server receives, as input, the current structured feature vectors and index records representing the present production state.

The server queries an information storage unit containing production history, failure events, and countermeasure outcomes, and computes similarity scores between current features and stored historical features using distance metrics.

The server selects similar cases whose similarity scores exceed a threshold and extracts relevant information such as failure types, applied countermeasures, and effectiveness ratings.

The server summarizes these cases into short natural-language descriptions and generates an additional prompt sentence, for example: “Past similar incidents include conveyor jams in the packaging process resolved by adding sensors and adjusting conveyor speed, and overheating in the heat treatment process resolved by lowering target temperature and increasing inspection frequency. Given these past incidents and the current state, propose defense measures that minimize unplanned downtime for the packaging and heat treatment processes.”

The server outputs the additional prompt sentence to be combined with current indices and features.

### Step 10:

The server prepares combined inputs for the generative AI model.

The server receives, as input, the main prompt sentence, the additional prompt sentence, and the structured feature tensors.

The server concatenates or otherwise arranges the prompt sentences into a single natural-language sequence, and tokenizes the sequence into tokens using a vocabulary.

The server embeds the tokens into numerical vectors using token embedding matrices and aligns the structured feature tensors with the token sequence by tagging tokens with process identifiers and time window references or by providing the tensors to a separate encoder.

The server outputs token embeddings and feature tensors formatted according to the input interface of the generative AI model.

### Step 11:

The server executes inference on the generative AI model.

The server receives, as input, token embeddings and structured feature tensors.

The server passes the feature tensors through an encoder network that computes intermediate representations via multiple layers of attention and feed-forward operations.

The server processes the token embeddings in a decoder network that attends to the encoder outputs, computing attention weights between tokens and process features in order to integrate quantitative indices into the text generation process.

The server runs forward propagation through all layers, computing, at each decoding step, probability distributions over vocabulary tokens using a softmax function.

The server selects or samples tokens according to the probabilities and assembles them into an output natural-language expression that includes recommended actions, rationales, and, optionally, risk scores or priorities.

The server outputs generated text that may contain phrases such as “increase capacity at the packaging process” or “introduce stricter inspection at the heat treatment process.”

### Step 12:

The server parses the generated text into structured strategy data.

The server receives, as input, the natural-language expression produced by the generative AI model.

The server applies text processing methods, including tokenization, part-of-speech tagging, and pattern matching, to identify action verbs, target process names or identifiers, and qualitative descriptors such as “increase,” “maintain,” “monitor,” or “reduce.”

The server classifies each identified action as an attack enhancement action or a defense maintenance action using rule-based mappings and, optionally, an auxiliary classifier trained on labeled examples.

The server assigns a priority score to each action using heuristics or numeric values present in the generated text (for example, “high priority” or “immediate action”).

The server outputs structured strategy objects, each containing at least a process identifier, an action type, a priority, and a description, stored in a database for subsequent retrieval.

### Step 13:

The server associates strategy objects with management and production indices and prepares strategy proposal information.

The server receives, as input, structured strategy objects and the previously computed index records.

The server links each strategy object to corresponding indices such as current throughput, defect rate, and downtime for the target process, and optionally computes estimated impacts using predictive models or rules.

The server aggregates related actions into coherent strategy sets, distinguishing attack-oriented sets from defense-oriented sets, and constructs summary explanations for each set.

The server outputs strategy proposal information that includes detailed actions, associated indices, and summary descriptions, in a format suitable for transmission to a terminal.

### Step 14:

The terminal receives and presents strategy proposal information to the user.

The terminal receives, as input, structured strategy proposal messages from the server over a network connection.

The terminal parses the messages, extracts lists of actions, indices, and summaries, and renders them in graphical and textual form on a display.

The terminal visually differentiates attack enhancement actions from defense maintenance actions using color codes or icons, and allows the user to sort and filter actions by process, priority, or expected effect.

The terminal outputs user-interface elements such as buttons and text fields through which the user can provide feedback.

### Step 15:

The user reviews proposed strategies and provides feedback.

The user receives, as input, visualized strategy proposal information on the terminal display.

The user examines each recommended action, considers supporting indices and historical case summaries, and decides whether to approve, reject, or request modification.

The user selects actions and sets their status (for example, “approved,” “rejected,” or “needs revision”) through the terminal's controls, and may also type additional instructions or constraints as free text prompt sentences, such as “Avoid recommending additional night shifts for the assembly process this month.”

The terminal sends, as output, structured feedback information and user-entered text back to the server.

### Step 16:

The server records user feedback and updates internal models or rules.

The server receives, as input, feedback information including approval flags, rejection flags, modification requests, and additional user instructions.

The server associates feedback entries with corresponding strategy objects and stores them in a feedback database.

The server analyzes patterns in the feedback, such as frequent rejection of certain action types under specific conditions, and adjusts prompt construction rules or feature extraction parameters accordingly.

The server may schedule retraining of parts of the generative AI model using labeled data derived from feedback and outcome measurements, thereby adjusting model parameters to better match user preferences and observed effectiveness.

The server outputs updated configuration parameters, revised prompts, or retrained model checkpoints for use in subsequent inference cycles.

### Step 17:

The server monitors post-implementation performance and refines strategy evaluation.

The server receives, as input, new time-series information from observation devices after approved actions have been executed in the production environment.

The server repeats preprocessing, feature extraction, and index calculation steps for the post-implementation period and compares indices against pre-implementation baselines.

The server computes performance deltas, such as changes in throughput, defect rate, or downtime, and labels each implemented strategy as effective, neutral, or ineffective based on predefined thresholds.

The server stores these labels and performance deltas as additional supervision data and uses them to adjust evaluation metrics, similarity search thresholds, and training datasets for the generative AI model.

The server outputs refined performance statistics and updated labels that influence future strategy generation and improve the overall precision and reliability of recommendations.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented decision support systems for business strategy typically separate numerical forecasting from narrative strategy formulation. In many such systems, one software component performs statistical or machine-learning based predictions over historical data, while another software component, or a human operator, manually interprets the prediction and drafts strategic guidance. This separation causes several technical problems in the computing environment.

First, conventional systems often treat user instructions as simple filter parameters or query strings rather than as rich natural-language inputs. As a result, the processor is not configured to systematically convert a user's strategic intent into machine-usable input that can jointly condition both numerical prediction and text generation. The system therefore cannot tightly couple the internal data representation (for example, time-series and attribute data) with a natural-language instruction, which leads to suboptimal utilization of computational resources and model capabilities.

Second, typical systems lack a unified control mechanism for a generative AI model that simultaneously consumes (i) preprocessed, structured business and external data and (ii) a prompt sentence expressing strategic objectives or constraints. Without such unified control, the processor cannot effectively align the model's attention between heterogeneous inputs, and must resort to separate processing pipelines or ad hoc integration logic. This increases processing latency, memory usage, and complexity of the software stack, and can cause inconsistent outputs when the numerical prediction path and the narrative generation path diverge.

Third, existing systems do not provide an efficient and repeatable mechanism for interactively updating strategic decisions in response to additional user instructions or changing market data. Typically, the system reloads data, recomputes features, and reconfigures model inputs in a largely manual or batch-oriented manner. This architecture fails to exploit the full capabilities of modern processors and memory hierarchies, because it does not maintain an analysis-ready data structure that can be incrementally updated and re-used by a generative AI model. As a result, interactive analysis sessions incur significant recomputation overhead, increased network traffic, and delayed response times.

Fourth, many known systems are not configured to automatically transform raw model outputs into structured strategic decision information that explicitly distinguishes offensive measures from defensive measures, while also satisfying constraint conditions such as budget limits or capacity thresholds. In such systems, post-processing is often ad hoc, implemented by separate tools or manual editing, and lacks tight integration with the inference process. This leads to redundant data transformations, inconsistent application of business rules, and inefficiencies in how the processor allocates compute and memory resources for visualization and presentation.

Accordingly, there is a need for an improved computer-implemented system in which a processor is specifically configured to (i) acquire and preprocess heterogeneous business and external data into analysis-ready structures, (ii) automatically generate and update a prompt sentence for a generative AI model based on user instructions and the analysis data, (iii) control model inference that jointly uses the prompt sentence and the analysis data, and (iv) post-process the model's numerical and natural-language outputs into consistent, structured strategic decision information that can be interactively updated and efficiently visualized. Such a system would address technical problems related to data integration, model control, interactive recomputation, and output structuring in a computing environment.

The specific processing by the specific processing unit 290 of the data processing device 12 in Example 2 is realized by the following means.

The present invention provides a server comprising a processor configured to acquire, via a communication interface, business information and external information required for strategic decision making from a plurality of information sources; preprocess the acquired business information and external information by executing data processing that includes complementing missing values, removing outliers, performing normalization, and converting formats, and structure the preprocessed data into analysis data including time-series information and attribute information; generate, based on an instruction sentence related to strategic decision making received from a user and the analysis data, a prompt sentence for input to a generative AI model, and control input of the prompt sentence and the analysis data to the generative AI model; obtain numerical prediction information and explanatory information in natural language output from the generative AI model, and generate strategic decision information including a plurality of defensive measures in accordance with predicted values and constraint conditions while classifying an action policy of an organization into an offensive measure or a defensive measure based on the numerical prediction information; convert the strategic decision information into output data including visualization data and explanatory text, and perform output control such that a display device presents the visualization data and the explanatory text as at least one of a graph display and a list display; and, upon receiving an additional instruction sentence or a change of conditions from the user, update the prompt sentence and the analysis data and rerun input to the generative AI model and generation of the strategic decision information to interactively update the strategic decision making. This enables the server to implement an integrated and technically improved pipeline in which heterogeneous data are transformed into analysis-ready structures, a generative AI model is precisely conditioned by both structured analysis data and a dynamically generated prompt sentence, and strategic decision information is produced, constrained, classified, and visualized in an interactive manner with reduced recomputation overhead, improved utilization of computing resources, and enhanced consistency between numerical forecasts and narrative strategy outputs.

The term “system” refers to an arrangement including at least one computing apparatus and associated components that cooperate to perform data acquisition, data processing, model inference, and output presentation for strategic decision making.

The term “processor” refers to one or more hardware processing units, such as a central processing unit or a graphics processing unit, capable of executing computer-readable instructions to perform the functions described herein.

The term “communication function” refers to hardware and software capabilities of the system that enable data transmission and reception over a wired or wireless communication network using one or more communication protocols.

The term “business information” refers to data related to operations of an organization, including but not limited to sales data, financial data, operational metrics, customer data, and internal performance indicators.

The term “external information” refers to data obtained from outside an organization, including but not limited to market data, economic indicators, competitor information, and industry statistics.

The term “information source” refers to any data provider or storage resource, including databases, application programming interfaces, data streams, and file repositories, from which the processor acquires business information or external information.

The term “preprocess” refers to performing one or more data transformation operations prior to analysis or model input, including cleaning, organizing, and normalizing data to convert it into analysis-ready form.

The term “data processing” refers to operations performed on data by the processor according to programmed logic, including arithmetic operations, logical operations, statistical operations, and format transformations.

The term “missing values” refers to absent or undefined data entries in a dataset where a value is expected according to the dataset schema.

The term “outliers” refers to data points that deviate significantly from other observations in a dataset according to statistical criteria or predefined rules.

The term “normalization” refers to transforming numerical data into a standardized range or distribution according to a predetermined method, such as scaling or standardization.

The term “format conversion” refers to changing the representation of data from one format to another, including but not limited to conversions between file formats, data types, or structural layouts.

The term “analysis data” refers to structured data generated by preprocessing that is suitable for computational analysis and model input, and that includes time-series information and attribute information.

The term “time-series information” refers to data values associated with time indices, representing measurements or observations taken at successive points in time.

The term “attribute information” refers to non-temporal properties or descriptors associated with data entities, such as category, region, product type, or customer segment.

The term “user” refers to a human operator who interacts with the system and provides instruction sentences, conditions, and other inputs related to strategic decision making.

The term “instruction sentence” refers to a natural-language or structured textual input provided by the user that expresses strategic objectives, constraints, or questions to be addressed by the system.

The term “prompt sentence” refers to a text sequence generated by the processor for input to a generative AI model, the text sequence being configured to condition the generative AI model to perform a specific analysis or generate a specific output.

The term “generative AI model” refers to a machine-learned model trained to generate outputs, including numerical predictions and natural-language text, in response to input data and a prompt sentence.

The term “numerical prediction information” refers to quantitative output values produced by the generative AI model, such as forecast values, probabilities, or scores.

The term “explanatory information in natural language” refers to textual output generated by the generative AI model that describes, explains, or justifies numerical prediction information or strategic recommendations.

The term “strategic decision information” refers to data generated by the processor that specifies one or more recommended actions, including offensive measures and defensive measures, for achieving organizational objectives under given conditions.

The term “offensive measure” refers to a recommended action that aims to increase growth, expand market presence, or otherwise proactively advance organizational objectives.

The term “defensive measure” refers to a recommended action that aims to mitigate risk, protect existing resources or positions, or otherwise preserve organizational stability.

The term “predicted values” refers to output values estimated by the generative AI model for future or hypothetical scenarios based on analysis data and the prompt sentence.

The term “constraint conditions” refers to limitations or requirements, such as budget limits, resource capacities, or policy rules, that restrict or shape the set of permissible recommended actions.

The term “visualization data” refers to data formatted for graphical representation, such as time-series values or categorized metrics prepared for charts or diagrams.

The term “explanatory text” refers to human-readable text that describes, summarizes, or clarifies the strategic decision information for presentation to the user.

The term “output data” refers to data generated by the processor for delivery to a display device or another output device, including visualization data and explanatory text.

The term “display device” refers to any apparatus capable of visually presenting information to the user, including but not limited to a monitor, a mobile device display, or a graphical user interface.

The term “graph display” refers to a visual representation of data using graphical elements such as lines, bars, or points arranged on a coordinate system.

The term “list display” refers to a presentation format in which items of information are arranged in an ordered or unordered list for display to the user.

The term “additional instruction sentence” refers to a subsequent instruction sentence provided by the user after an initial analysis, the subsequent instruction sentence requesting a modification, refinement, or extension of the strategic decision information.

The term “change of conditions” refers to a modification of one or more parameters, constraints, or assumptions used in the analysis, such as altering a time range, budget limit, or target region.

The term “interactive update” refers to a process in which the system repeatedly receives user inputs, updates internal data and model inputs, and generates new outputs in a session-based or continuous manner.

The term “user screen” refers to a graphical user interface or other display arrangement through which the user views information and inputs data or instructions.

The term “manager” refers to a user having responsibility for operational or tactical decisions within an organization.

The term “decision maker” refers to a user having responsibility for strategic or high-level decisions within an organization.

The term “management indices” refers to quantitative or qualitative indicators used to evaluate the performance or status of an organization, such as revenue, profit margin, or risk metrics.

The term “risk factors” refers to variables or conditions that may negatively affect organizational performance or objectives, such as volatility indicators, dependency measures, or exposure metrics.

The term “analysis target range” refers to a scope for analysis defined by boundaries such as time period, geographic region, business unit, or product group.

The term “market-related information source” refers to an information source that provides data about market conditions, including demand measures, price indices, or sector trends.

The term “competitor-related information source” refers to an information source that provides data about the activities, performance, or positions of competing entities.

The term “real time” refers to a mode of operation in which data is acquired, processed, and used for decision making with latencies that are sufficiently low for the results to be considered current for the application context.

The term “predetermined cycle” refers to a fixed or configurable time interval at which the system is scheduled to perform acquisition or update of data.

The term “inference process” refers to execution of the generative AI model using current inputs, including the prompt sentence and analysis data, to produce outputs such as numerical prediction information and explanatory information.

The term “market environment” refers to a set of external conditions, including market trends, competitive landscape, and macroeconomic variables, that influence business performance and strategic decisions.

In one embodiment, a server, a terminal, and a user cooperate to implement the invention. The server is implemented as an information processing apparatus including at least one central processing unit, at least one graphics processing unit, a main memory, a nonvolatile storage device, and a network interface. For example, the server uses a multi-core general-purpose processor, a programmable graphics processing device supporting parallel tensor operations, a volatile memory device such as a dynamic random-access memory, a nonvolatile storage device such as a solid-state storage device, and a network interface supporting packet-based communication over an external network. The server executes an operating system such as a general-purpose server operating system and runs application software implemented using an application execution environment such as a runtime for an interpreter language or a compiled language.

The terminal is implemented as a user-side computing apparatus, for example a desktop computing apparatus, a portable computing apparatus, or a mobile communication apparatus, and comprises a processor, a memory, a display device, an input device, and a communication interface. The terminal executes a user interface program such as a web browser or a native application to present graphical elements to the user and to transmit and receive data to and from the server using a communication protocol such as a secure hypertext transfer protocol.

The user operates the terminal to access a user interface provided by the server. The user interface displays input controls for strategic analysis, such as text input fields, selection boxes for time ranges and regions, and controls for specifying management indices and risk factors. The user enters a prompt sentence expressing a strategic request. Examples of the prompt sentence include:

“Please provide the sales forecast for the next quarter and propose the optimal marketing strategy based on the forecast.”

“Assess the risk of revenue decline over the next six months and recommend defensive strategies to minimize that risk.”

“Simulate an aggressive growth strategy for our top three product categories in Europe and estimate the expected sales uplift.”

The terminal transmits the prompt sentence and additional parameters, such as selected regions, time windows, and management indices, to the server.

In one embodiment, the server executes a program configured to acquire business information and external information. The server uses the network interface to send structured data retrieval requests. For internal data, the server uses a database management system executing on the same or a different computing apparatus, such as a relational database, and performs structured query language queries to retrieve historical transaction records, financial records, and internal performance indicators. For external data, the server establishes connections to external data providing services through an application programming interface and exchanges messages encoded in a structured text format.

The server stores received raw data in main memory and/or the nonvolatile storage device. The server then executes a preprocessing module implemented using a data analysis library such as a data frame processing library. The server converts heterogeneous input formats (for example, table-oriented query results and structured text data) into a unified data structure, such as a tabular structure indexed by time and attribute. The server performs data cleaning operations including:
(1) Missing value completion: The server identifies empty or undefined entries and replaces them using statistical values (such as mean, median, or mode) computed per feature, or by forward filling or interpolation across time. This uses vectorized operations on the data structure and reduces branching operations, thereby utilizing cache locality and improving processing throughput.
(2) Outlier handling: The server computes statistical measures (such as quantiles or standard deviation) for each numeric attribute, compares each data point to threshold values, and removes or caps values that exceed thresholds. This reduces the influence of extreme values on subsequent model training or inference.
(3) Normalization: The server applies numerical transformations to scale features into a standardized range, such as zero mean and unit variance, using vectorized operations over columns. The normalized representation improves numerical stability and convergence behavior in the neural network used by the generative AI model.
(4) Format conversion: The server converts time strings to an internal time representation and aggregates records into fixed time intervals such as days, weeks, or quarters. The server also converts categorical attributes into integer indices suitable for embedding layers.

By structuring the data into a unified analysis data structure including time-series information and attribute information, the server can reuse the data structure across multiple inferences and incremental updates without rebuilding it from scratch, which reduces recomputation and memory allocation overhead and improves data management efficiency.

In one embodiment, the server hosts a generative AI model implemented as a neural network. The generative AI model includes an encoder part for numerical and categorical business features and a decoder part for natural-language generation. The encoder part receives as input tensors representing time-series features, such as historical sales amounts, marketing spend, and external indices, arranged in a three-dimensional tensor (batch dimension, time dimension, feature dimension). The encoder part also receives embedded categorical attributes such as region, product category, and customer segment.

In an example configuration, the encoder part uses a stack of neural network layers, such as recurrent neural network layers, temporal convolution layers, or transformer encoder layers, combined with attention mechanisms that compute weighted combinations of time-step representations. The decoder part is implemented as a transformer decoder or other sequence generation network, which receives token embeddings produced from a prompt sentence and attends to the encoded business features and context vectors.

The server stores the model parameters in the nonvolatile storage device and loads them into main memory and the graphics processing unit memory at runtime. During training, the server uses an optimization algorithm such as a gradient-based optimizer to minimize a loss function that combines a numerical prediction error component (for example, mean squared error between predicted and actual sales) and a language modeling component (for example, cross-entropy loss over generated tokens). The server updates weights by computing gradients through backpropagation and applying parameter updates in floating point arithmetic optimized for the graphics processing architecture. Data augmentation techniques, such as random subsequence sampling of time windows or perturbation of exogenous features, can be applied to improve robustness.

At inference time, the server receives the prompt sentence from the terminal. The server uses a tokenizer to convert the prompt sentence into a sequence of token identifiers. The server combines the token sequence with a fixed prefix that encodes instruction structure, such as an instruction section and a data reference section. The server then forms a prompt input tensor representing the sequence of tokens and feeding them through an embedding layer.

The server also selects relevant slices of the analysis data, such as the last several time steps and selected attributes corresponding to the region and product category in the prompt sentence. The server then feeds the analysis tensor to the encoder part and the token embeddings to the decoder part. Attention mechanisms inside the network compute similarity scores between token representations and encoded feature vectors, and generate context vectors that condition token generation on numeric trends and categorical context.

The server controls decoding using a search algorithm such as beam search or nucleus sampling with tunable parameters (for example, beam width, temperature, and top-p threshold) to generate explanatory text that describes forecasts and strategies. Simultaneously, a prediction head attached to the encoder outputs a multi-step forecast for relevant numeric quantities, such as sales per quarter, expected conversion rates, and risk probabilities.

The server applies a rule-based post-processing module to combine the numeric predictions and generated text. For example, the server compares predicted values to thresholds defined by constraint conditions (such as budget limits and capacity limits) and automatically classifies recommended actions as offensive measures or defensive measures. In one rule set, an action that increases spending in a segment with predicted above-threshold growth is labeled as an offensive measure, whereas an action that reduces exposure in a segment with high predicted risk is labeled as a defensive measure. The rules are implemented as decision trees or conditional logic executed by the processor, and they modify and annotate the model output before presentation.

The server converts the consolidated strategic decision information into visualization data structures. For a time-series forecast, the server builds an array of time-value pairs with metadata specifying chart type and axis labels. For recommendations, the server constructs list item structures with labels indicating offensive or defensive classification. These structures are serialized into an output message and transmitted to the terminal.

The terminal receives the output message and uses a visualization library within the user interface program to render line graphs, bar charts, and lists. The terminal presents, for example, a graph of predicted quarterly sales and a list of recommended measures, grouped into offensive and defensive categories. The user can inspect the information and adjust parameters or issue additional instructions.

When the user enters a new prompt sentence or modifies constraints, the server does not discard the entire analysis data structure. Instead, the server updates only the affected portions of the data (for example, appending the latest market data or re-filtering by a new region) and regenerates the prompt sentence with updated context. Because the analysis data and model state are maintained in memory, the server avoids redundant data loading and preprocessing operations, which reduces memory traffic and computation time. This design improves processing speed and reduces network load compared to systems that perform full pipeline recomputation for each query.

From a technical perspective, the described arrangement improves computer technology in several ways. By encoding heterogeneous business and external data into a unified analysis tensor and by conditioning the generative AI model simultaneously on this tensor and a dynamically generated prompt sentence, the server exploits the parallelism of the graphics processing unit more efficiently than traditional separated pipelines. Because the encoder and decoder share internal representations across both numeric prediction and language generation tasks, intermediate activations can be reused, reducing redundant computations and improving energy efficiency.

Further, the server's explicit control over missing value completion, outlier handling, and normalization, combined with the integrated loss function during training, reduces numerical instability and gradient explosion phenomena that often occur in naive implementations. As a result, forecast accuracy and text relevance are both improved, as measured by reduced prediction error and improved linguistic coherence for given computational resources.

The design also introduces a non-conventional dataflow: instead of merely passing raw query parameters to a model, the server generates a structured prompt sentence that encodes not only the user's request but also references to internal analysis structures and constraint conditions. This structured prompt acts as a form of meta-data about the current analysis context, enabling the generative AI model to focus on relevant subspaces of the feature manifold. This reduces the effective search space of the decoder, thereby speeding up convergence during decoding and reducing the number of tokens that need to be processed.

In certain embodiments, the server stores an index that maps combinations of regions, time ranges, and product groups to precomputed feature representations. When a user issues a related prompt sentence, the server retrieves and reuses these feature representations rather than recomputing encodings from raw data. This caching mechanism is implemented at the tensor level and is coordinated with the generative AI model's input layer, further reducing latency and memory bandwidth use.

The system's technical effects are not limited to automation of human reasoning. A human operator would not be able to maintain, in working memory, the high-dimensional tensor representation of multivariate time-series data and its alignment with token-level representations of instruction sentences. The server's architecture specifically exploits vectorized operations, neural attention mechanisms, and caching strategies to achieve a speed and scale of analysis that are unattainable by manual methods. Additionally, by maintaining an interaction loop that updates the prompt sentence and analysis data without reconstructing the entire pipeline, the server reduces the number of I/O operations and context switches at the operating system level, thereby improving throughput in multi-user scenarios.

In alternative embodiments, the generative AI model architecture can be varied. The encoder part may be implemented as a multi-layer recurrent unit with gating mechanisms, a temporal convolution network, or a multi-head self-attention network. The decoder part may employ different positional encodings or attention head configurations to optimize for longer or shorter prompt sentences. The loss function may incorporate regularization terms that penalize excessive volatility in predicted series or inconsistency between numeric predictions and textual descriptions.

In another variation, the server can employ a hybrid model where separate sub-models handle different segments of the input space (for example, one sub-model for high-frequency data and another for low-frequency macro data). The server then merges intermediate representations through a fusion layer. This modular design allows the system to be tuned for different industries or data characteristics while preserving the same overall flow of generating and controlling prompt sentences for a generative AI model.

The terminal implementation can also vary. In one embodiment, the terminal runs a native application storing part of the visualization logic locally, which reduces the amount of graphical data transmitted from the server. In another embodiment, the terminal uses a web-based interface but caches static assets and configuration data, so that only compact numeric and textual payloads need to be transmitted. These configurations reduce communication load and improve responsiveness.

Through these embodiments and variations, the server, terminal, and user cooperate to implement a system in which structured preprocessing, prompt sentence generation, neural network-based inference, and rule-based post-processing are tightly integrated at the level of data structures and control flow. This produces a technical improvement in the way computing resources are used to generate forecasts and strategic decision information, resulting in improved processing speed, improved prediction quality, reduced error due to inconsistent pipelines, and reduced communication overhead in interactive strategic analysis sessions.

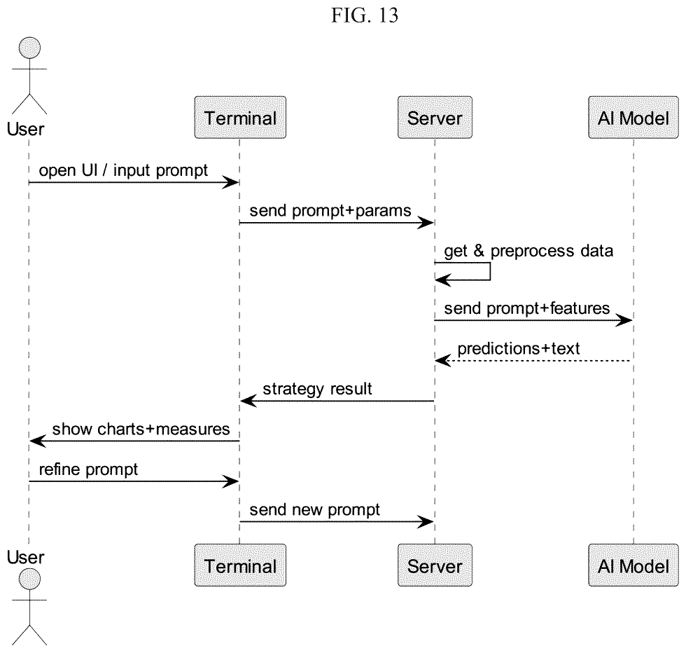

The following describes the processing flow using FIG. 13.

### Step 1:

User operates the terminal to start a strategic analysis session.

User opens a user interface on the terminal using a web browser or a native application and selects an analysis mode, such as “Quarterly sales forecast and strategy.”

Input: User's selection of analysis mode and authentication information.

Output: A displayed input screen including a text input field for a prompt sentence and selection controls for parameters such as region, period, and product category.

### Step 2:

User inputs a prompt sentence and analysis parameters on the terminal.

User types a prompt sentence into the text field, for example, “Please provide the sales forecast for the next quarter and propose the optimal marketing strategy based on the forecast.” and selects one or more parameters such as target region and target product group.

Input: User keystrokes and UI selections.

Output: A structured set of user inputs stored in the terminal's memory, including the prompt sentence text and parameter values.

### Step 3:

Terminal transmits the prompt sentence and parameters to the server.

Terminal constructs a request message including the prompt sentence, selected parameters (for example, region, time range, management indices), and a session identifier, and sends the message to the server via a secure communication protocol.

Input: Structured user input data (prompt sentence and parameters).

Output: A network request packet containing the user input data delivered to the server.

### Step 4:

Server receives and validates the request.

Server parses the incoming request, extracts the prompt sentence and parameter values, verifies the session identifier, and checks that mandatory fields (such as period and region) are present and valid.

Input: Network request packet from the terminal.

Output: Validated request data stored in server memory, including the prompt sentence and normalized parameter values; in case of invalidity, an error response object.

### Step 5:

Server acquires internal business data based on the request.

Server uses a database interface to send structured queries to one or more internal data stores to retrieve historical sales, costs, marketing spend, and related business indicators for the requested region and period.

Input: Validated request data specifying region, time range, and product group.

Output: Raw internal business data records, for example, rows of historical transactions and aggregated metrics, loaded into server memory.

### Step 6:

Server acquires external information from external sources.

Server uses network APIs to call external data services and obtains market indicators, competitor activity indices, and macroeconomic variables matching the request parameters.

Input: Validated request data specifying analysis scope.

Output: Raw external data in structured formats, such as tables or structured text, stored in server memory.

### Step 7:

Server merges internal and external data into a unified raw dataset.

Server aligns internal and external records by keys such as time, region, and product category, merging them into one composite table to form a unified raw dataset.

Input: Raw internal business data and raw external data.

Output: A combined raw dataset where each record includes business metrics and corresponding external indicators.

### Step 8:

Server preprocesses the combined raw dataset.

Server executes data cleaning operations to fill missing values, remove or cap outliers, normalize numeric columns, and convert time strings to time indices. The server uses statistical calculations and vectorized arithmetic to apply these transformations.

Input: Combined raw dataset containing mixed-quality records.

Output: A cleaned and normalized dataset, with consistent formats, ready for feature extraction.

### Step 9:

Server structures the preprocessed data into analysis data.

Server converts the cleaned dataset into an analysis data structure that includes time-series arrays for numerical metrics and index-coded arrays for categorical attributes.

Input: Cleaned and normalized dataset.

Output: Analysis data consisting of one or more arrays or tensors representing time-series features, attribute encodings, and associated metadata.

### Step 10:

Server selects relevant analysis slices for the current request.

Server filters the analysis data to keep only the time range, regions, and product groups specified by the user, and extracts a fixed-length time window suitable for the generative AI model.

Input: Analysis data and validated request parameters.

Output: A subset of analysis data tensors corresponding to the requested context, including a time-series slice and associated attribute vectors.

### Step 11:

Server generates a structured prompt sentence for the generative AI model.

Server constructs a model-facing prompt sentence that includes the user's prompt sentence and additional context, such as encoded management indices, risk factors, and constraint descriptions, and formats this text according to a predefined instruction template.

Input: User's original prompt sentence and validated request parameters.

Output: A structured prompt sentence text specifically designed to condition the generative AI model.

### Step 12:

Server tokenizes the structured prompt sentence.

Server converts the structured prompt sentence into token identifiers using a tokenizer associated with the generative AI model, producing a sequence of integer token IDs.

Input: Structured prompt sentence text.

Output: A token sequence representing the prompt sentence, ready for embedding.

### Step 13:

Server transforms analysis data into feature tensors for the generative AI model.

Server maps analysis data into numerical tensors with predetermined shapes, including batch dimension, time dimension, and feature dimension, and converts categorical indices into embeddings or one-hot vectors.

Input: Selected analysis data slices.

Output: One or more numerical tensors containing time-series features and attribute embeddings.

### Step 14:

Server loads the generative AI model and prepares it for inference.

Server retrieves trained model parameters from storage, loads them into memory and into a graphics processing unit, and configures computational graphs for encoder and decoder components.

Input: Model parameter files and model configuration settings.

Output: An instantiated generative AI model object in memory, ready to receive feature tensors and token sequences.

### Step 15:

Server performs encoding of analysis data.

Server feeds the feature tensors into the encoder portion of the generative AI model, which computes hidden state representations across time and attributes using neural network layers and attention mechanisms.

Input: Numerical feature tensors.

Output: Encoded feature representations, such as a sequence of context vectors summarizing historical and contextual information.

### Step 16:

Server performs embedding of the prompt token sequence.

Server passes the token identifiers through an embedding layer and adds positional encodings to generate embedded token vectors for the decoder input.

Input: Token sequence representing the structured prompt sentence.

Output: Embedded token vectors with positional information suitable for decoder processing.

### Step 17:

Server performs decoding conditioned on encoded features and prompt embeddings.

Server runs the decoder portion of the generative AI model, which attends to the encoded feature representations while generating token-by-token outputs that form explanatory text and, where applicable, intermediate decision tokens.

Input: Encoded feature representations and embedded prompt token vectors.

Output: A sequence of output token distributions over the vocabulary and optional intermediate numeric outputs from prediction heads.

### Step 18:

Server generates numeric predictions from prediction heads.

Server uses dedicated output layers attached to the encoder to compute predicted numeric values, such as future sales or risk probabilities, by applying learned weights to the encoded representations.

Input: Encoded feature representations.

Output: Numerical prediction vectors representing time-series forecasts and risk measures.

### Step 19:

Server converts token distributions into natural-language explanatory text.

Server applies a decoding algorithm, such as beam search or sampling, to convert the sequence of output token distributions into a concrete sequence of tokens, and then decodes these tokens back into natural-language text.

Input: Sequence of token probability distributions.

Output: Explanatory text that describes forecast results and strategic suggestions.

### Step 20:

Server combines numeric predictions with explanatory text into intermediate decision data.

Server links each numeric prediction (such as forecasted sales for a period) to the relevant section of explanatory text and stores them as a structured intermediate decision object.

Input: Numerical prediction vectors and explanatory text.

Output: Intermediate decision data pairing numbers with corresponding narrative explanations.

### Step 21:

Server applies rule-based classification of measures into offensive and defensive categories.

Server evaluates the numeric predictions against constraint conditions, such as thresholds on growth or risk, and classifies recommended actions extracted from the explanatory text as offensive measures or defensive measures according to predefined rules.

Input: Intermediate decision data and constraint conditions.

Output: Classified recommendations where each suggested measure is labeled as either an offensive measure or a defensive measure.

### Step 22:

Server generates final strategic decision information.

Server assembles forecasts, classified measures, and constraint compliance results into a final structured object representing strategic decision information for the requested scenario.

Input: Classified recommendations and associated numeric predictions.

Output: A final strategic decision information structure containing forecasts, offensive measures, defensive measures, and explanatory text.

### Step 23:

Server converts strategic decision information into visualization data.

Server constructs visualization-ready data structures such as arrays of time-value pairs for line charts, grouped values for bar charts, and lists for recommended actions, and attaches presentation metadata such as labels, colors, and groupings.

Input: Final strategic decision information structure.

Output: Visualization data and descriptive text prepared for transmission to the terminal.

### Step 24:

Server transmits output data to the terminal.

Server serializes visualization data and descriptive text into a response message and sends it to the terminal through the network interface.

Input: Visualization data and descriptive text.

Output: A network response containing chart data, recommendation lists, and explanatory text received by the terminal.

### Step 25:

Terminal renders visualizations and text for the user.

Terminal parses the response, uses internal rendering functions to draw graphs and lists on the display device, and arranges textual explanations in association with visual elements.

Input: Network response from the server containing visualization data and text.

Output: A rendered user interface on the display showing forecast graphs, offensive and defensive measures, and explanatory text.

### Step 26:

User reviews the results and optionally refines the prompt sentence.

User examines the visualized forecasts and recommendations, modifies conditions such as time range or target region, and inputs a refined prompt sentence, for example, “Refine the strategy focusing only on online channels and a marketing budget of 1 million dollars.”

Input: Displayed results and user's strategic intentions.

Output: Updated user input data for a subsequent analysis cycle, which is transmitted again to the server to repeat the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented decision support systems typically separate analytical computation from natural-language advisory output, and rely on static rule sets or manually crafted templates. Such systems suffer from several technical shortcomings. First, processors in these systems usually apply fixed scoring logic to structured data and then render the results in predetermined text formats; they are not configured to dynamically construct machine-interpretable prompt sentences that unify heterogeneous data types such as numerical operational metrics, unstructured external information, and emotion state information. As a consequence, the interaction between the analytical computation pipeline and a generative artificial intelligence model is rudimentary, leading to inefficient utilization of computing resources and limited adaptability of the generated strategies.

Second, known systems generally treat predictive models and natural-language models as independent components. Prediction models compute performance indicators, and generative models produce advisory text, but there is no technical mechanism in the processor to feed back execution results and user evaluations into both the prediction model and the prompt construction logic. This absence of closed-loop adaptation prevents the system from improving its internal models and prompt generation rules over time, resulting in sub-optimal prediction accuracy, unstable recommendation quality, and unnecessary computational repetition.

Third, conventional systems tend to ignore user emotion states and rapidly changing external conditions at the system architecture level. Processors in such systems are not configured to preprocess and integrate emotion data together with operational and market data, nor to condition the generative artificial intelligence model on such integrated context. As a result, strategic judgments are computed without regard to user cognitive load or stress, and without tight coupling to real-time environmental changes, which can lead to frequent context switching, inefficient decision cycles, and increased overhead for human users and computing devices.

Therefore, there is a need for an improved computer-implemented system in which a processor is specifically configured to (i) acquire and preprocess heterogeneous data including numerical, textual, and emotion data, (ii) execute prediction models to derive performance indicators, (iii) construct rich prompt sentences that encode performance indicators, user emotion states, and environmental states as machine-interpretable input to a generative artificial intelligence model, (iv) apply post-processing conditions to the output of the generative artificial intelligence model to select and adjust offensive or defensive measures, and (v) update both the prediction models and the prompt construction rules based on feedback from actual execution results and user evaluations. Such a configuration improves the internal operation of the computer system itself by optimizing data flows between analytical and generative components, reducing redundant computation, and enabling adaptive, context-aware strategy generation with fewer manual interventions.

The specific processing by the specific processing unit 290 of the data processing device 12 in Application Example 2 is realized by the following means.

The present invention provides a server comprising a processor configured to acquire information required for strategic decision making from internal and external data sources, preprocess the acquired information and detection signals from operating equipment to generate numerical data, character data, and emotion data, execute at least one prediction model based on the numerical data to calculate performance indicators including at least one of productivity indicators and market indicators, generate explanatory text representing at least one of the performance indicators, a user emotion state, and an environmental state, construct a prompt sentence including the explanatory text, input the prompt sentence into a generative artificial intelligence model to obtain a response including a strategic judgment indicating whether to attack or to defend and including a plurality of action plans, apply conditions based on at least one of the emotion data and outputs of the prediction model to the strategic judgment and the action plans to select and adjust at least one of a defensive measure and an offensive measure, present the adjusted strategic judgment and the adjusted action plans to a user terminal and collect at least one of an execution result and an evaluation from a user, and update at least one of the prediction model and rules for constructing the prompt sentence based on the execution result or the evaluation. This enables improvement of computer functionality by allowing the server to dynamically couple analytical prediction and generative reasoning within a closed feedback loop, to generate context-aware prompt sentences that efficiently drive the generative artificial intelligence model, to reduce redundant processing by adapting models and prompt rules to real-world outcomes, and to provide more stable and responsive strategic judgments while reducing computational overhead and user interaction burden.

The term “processor” refers to a hardware or virtual computing element, such as a central processing unit or execution core, configured to execute program instructions for performing data acquisition, preprocessing, model inference, prompt construction, and user interaction processing.

The term “information required for strategic decision making” refers to data used by the processor to compute or support a choice between alternative courses of action, including at least operational data, market data, competitor data, environmental data, and user-related data.

The term “detection signals from operating equipment” refers to signals output from physical apparatus, such as sensors, controllers, or machines, indicating states or measurements including at least temperature, pressure, utilization, error status, or throughput.

The term “numerical data” refers to data represented by numbers suitable for mathematical or statistical processing, including at least time-series measurements, counts, ratios, or indicators derived from raw signals.

The term “character data” refers to data expressed as text or symbols, including at least natural-language strings, labels, identifiers, and textual descriptions obtained or generated by the processor.

The term “emotion data” refers to data representing an estimated emotional state of a user, derived from at least one of voice information, facial image information, textual expressions, or physiological signals.

The term “prediction model” refers to a computational model implemented in software or hardware, configured to receive input features and output predicted values of one or more performance indicators using at least one of statistical methods, machine learning methods, or artificial intelligence methods.

The term “performance indicators” refers to quantitative measures computed by the prediction model that characterize performance of a process or system, including at least productivity indicators and market indicators.

The term “productivity indicators” refers to performance indicators related to efficiency or output of an operational process, including at least throughput, utilization, cycle time, yield, or cost efficiency.

The term “market indicators” refers to performance indicators related to a market environment, including at least demand levels, price indices, volatility measures, or sales trends.

The term “user emotion state” refers to a classification or parameter set describing a psychological or affective condition of a user, such as stress, relaxation, anxiety, or confidence, estimated from emotion data.

The term “environmental state” refers to information describing conditions external to the user and the processor, including at least operational environment conditions, market conditions, and social conditions.

The term “explanatory text” refers to character data generated by the processor that describes, in natural language or structured text, at least one of the performance indicators, the user emotion state, and the environmental state.

The term “prompt sentence” refers to a character-string input constructed by the processor for a generative artificial intelligence model, the character-string including the explanatory text and instructions that specify a requested output behavior of the generative artificial intelligence model.

The term “generative artificial intelligence model” refers to a computational model trained using machine learning techniques to generate output data, such as natural-language text, in response to an input prompt sentence.

The term “strategic judgment” refers to a decision produced by the generative artificial intelligence model indicating at least whether a recommended course of action should be offensive (attack) or defensive (defend), and optionally including reasoning or prioritization.

The term “action plans” refers to one or more sequences or sets of recommended actions associated with the strategic judgment, including at least operational steps, configuration changes, resource allocations, or timing decisions.

The term “offensive measure” refers to an action plan classified as attack, configured to increase exposure to opportunity or risk, such as expansion, aggressive investment, or increased production.

The term “defensive measure” refers to an action plan classified as defend, configured to reduce exposure to risk or stabilize performance, such as downsizing, cost reduction, or conservative allocation.

The term “conditions based on emotion data and outputs of the prediction model” refers to decision rules or constraints that the processor applies using at least the user emotion state and the performance indicators to modify or filter the strategic judgment and the action plans.

The term “user terminal” refers to an information processing device operated by a user, such as a mobile device, wearable device, or workstation, configured to transmit input information to the server and present output information from the server.

The term “execution result” refers to information indicating how at least one part of an action plan or strategic judgment was carried out in a real or simulated environment, including observed outcomes or performance changes.

The term “evaluation” refers to information indicating a user's assessment of a strategic judgment or action plan, including at least ratings, feedback comments, or acceptance or rejection flags.

The term “rules for constructing the prompt sentence” refers to definitions, templates, or algorithms used by the processor to select, order, and format elements of explanatory text and control instructions to form the prompt sentence supplied to the generative artificial intelligence model.

The term “management indicators” refers to numerical or categorical values describing a status of an organization from a management perspective, including at least financial metrics, risk metrics, and operational metrics.

The term “risk factors” refers to variables or conditions that can negatively affect system or business performance, including at least market risks, operational risks, and regulatory risks.

The term “desired explanation format” refers to a specification received from the user terminal indicating a preferred structure, style, length, or representation form of the explanation provided to the user.

The term “management-level user” refers to a user having decision-making responsibility at an organizational management level, such as an executive or senior manager.

The term “supervisory-level user” refers to a user having responsibility for oversight of a department, project, or process, such as a manager or team leader.

The term “time-series external information” refers to data obtained from sources outside the server that varies over time, including at least market information, competitor information, and social condition information.

The term “market information” refers to external data describing a state of a commercial or financial market, including at least prices, volumes, indices, and demand statistics.

The term “competitor information” refers to external data describing activities or conditions of entities competing in a relevant domain, including at least product changes, pricing, and market share.

The term “social condition information” refers to external data describing societal situations or trends, including at least economic conditions, public sentiment, and policy changes.

In one embodiment, a server implements the claimed system as a network-connected computing apparatus including at least one processor, a main memory, a non-volatile storage, and a communication interface. The server executes an operating system and one or more application programs written, for example, in a general-purpose programming language. The server stores machine-readable instructions and trained model parameters in the non-volatile storage and loads them into the main memory when performing the processes described below. A plurality of terminals, such as handheld devices, wearable display devices, and workstation terminals, communicate with the server via a communication network.

The server acquires information required for strategic decision making from multiple heterogeneous sources. The server acquires operational signals from operating equipment, for example by receiving measurement values from sensors connected to controllers through an industrial communication protocol. In one example, the sensors output temperature, vibration, throughput, and error status values, and the controllers transmit these values in a packetized format over a local network to the server. The server also acquires external information, such as market information and social condition information, from external data sources via an application programming interface and by retrieving documents from network resources. The server further acquires user-related information, including at least audio signals and images captured at the terminals.

The server preprocesses the acquired information and detection signals from the operating equipment to generate numerical data, character data, and emotion data. The server implements a data preprocessing module which converts the sensor measurements into numerical data structures, for example matrix or table structures where each row corresponds to a sampling time and each column corresponds to a standardized feature such as normalized temperature or normalized throughput. The server removes invalid records, interpolates missing values using statistical interpolation, and normalizes each feature into a predefined numeric range. For external text information, the server performs parsing, tokenization, stop-word removal, and encoding into character sequences or numerical embeddings. For user audio and image data, the server performs signal conditioning, such as noise reduction and normalization of image intensity, and extracts acoustic features and facial geometry features which form the basis of the emotion data. The server maps those features to an emotion label and a continuous emotion strength value, and stores them in association with the corresponding user identifier and time.

The server executes at least one prediction model based on the numerical data to calculate performance indicators including productivity indicators and market indicators. In one embodiment, the server implements the prediction model as a gradient-boosted decision tree model or a random forest model that receives feature vectors derived from the preprocessed numerical data and outputs predictions such as future throughput, expected failure probability, or forecasted market index levels. In another embodiment, the server implements the prediction model as a neural network, such as a recurrent neural network or temporal convolutional network, in which the server organizes the numerical data as time-series sequences. The server computes an error function, such as a mean squared error between predicted indicators and observed indicators, during an offline training phase, and adjusts the model weights by an optimization algorithm, such as stochastic gradient descent or a variant. The server stores the trained weights and later uses the model in an inference mode, where the server receives new numerical input and outputs updated performance indicators with reduced prediction error relative to prior models.

The server generates explanatory text representing at least one of the performance indicators, a user emotion state, and an environmental state. The server implements a text generation module that converts the current values of performance indicators, such as “production line A efficiency 62% against target 85%” or “market volatility index high,” into natural language phrases. The server further appends information describing the user emotion state, such as “the decision-maker is under high stress,” and environmental state, such as “sustained increase in input material cost.” The resulting explanatory text is encoded as character data.

The server constructs a prompt sentence including the explanatory text. The server applies rules for constructing the prompt sentence, which define an order, a grouping, and control tokens to be used when forming the input for a generative AI model. The server stores these rules as templates and dynamic selection logic. For example, when the prediction model outputs a low productivity indicator and the emotion data indicates high user stress, the server selects a conservative template and generates a prompt sentence such as: “You are a strategic advisor for an industrial plant. Current data: line A is predicted at 62% efficiency versus target 85%, with a bottleneck at station 3 and elevated temperature on the main machine. The manager is currently under high stress. Based on this data, propose a conservative production strategy to remove the bottleneck while avoiding overload. Decide whether we should attack (increase output aggressively) or defend (stabilize and reduce risk), and explain why.”

In a market scenario, the server generates a prompt sentence such as:

“Given the following macroeconomic indicators: inflation 5.1%, unemployment 4.3%, a decreasing consumer confidence index, and a high volatility index, predict the market trend over the next quarter and recommend an optimal investment strategy. Indicate clearly whether the strategy is offensive (attack) or defensive (defend), and list specific defensive measures if you recommend defense.”

In a retail emotion scenario, the server generates a prompt sentence such as:

“A customer in the store appears stressed according to facial expression and voice analysis. Propose defensive measures to reduce the customer's stress and improve the in-store experience, including changes to environment, communication style, or discounts.”

The server inputs the constructed prompt sentence into a generative AI model. The generative AI model is implemented, for example, as a transformer-based neural network comprising an embedding layer, a plurality of self-attention layers, and an output layer that maps internal representations to token probabilities. During training, the server or another training apparatus receives a large corpus of text, constructs input-output pairs, computes a loss function such as cross-entropy between predicted token distributions and ground truth tokens, and updates the model parameters by backpropagation and a gradient-based optimization method. The trained generative AI model is then deployed on the server in inference mode.

The server converts the prompt sentence into a sequence of input tokens according to a predetermined tokenization scheme and passes the tokens to the generative AI model. The generative AI model processes the tokens through its attention layers, using learned attention weights to focus on relevant components of the explanatory text and instructions. The model outputs a sequence of tokens that the server decodes into character data. The generated character data includes at least a strategic judgment indicating whether to attack or defend, and one or more action plans that include detailed instructions.

The server applies conditions based on the emotion data and the outputs of the prediction model to the strategic judgment and the action plans to select and adjust at least one of a defensive measure and an offensive measure. The server uses a post-processing module that incorporates non-standard rules beyond simple human heuristics. For example, the server evaluates the magnitude of predicted risk from the prediction model and the severity of the user emotion state. If the prediction model indicates a high risk of failure or downturn and the emotion state indicates stress or anxiety, the server modifies any overly aggressive offensive action plans generated by the generative AI model, for instance by downscaling target values or inserting additional safety checks. The server may also re-rank multiple candidate action plans by a scoring function that combines predicted outcomes, risk measures, and consistency with user emotion constraints. This post-processing logic reduces the variance of generated strategies and avoids configurations that would otherwise overload the operating equipment or cognitive capacity of the user.

The server presents the adjusted strategic judgment and the adjusted action plans to the terminals. The terminals display the results on a screen, a head-mounted display, or another output device. The terminals allow the user to inspect a summarized decision, for example “Defend: stabilize production and delay expansion,” and to access detailed step-by-step instructions. The terminals further provide input interfaces that permit the user to submit execution results, such as success or failure flags, and evaluations, such as ratings and free-text feedback.

The server collects and records the execution results and evaluations from the terminals. The server stores these as records associated with corresponding prompt sentences, generative AI outputs, performance indicators, and emotion data. The server updates at least one of the prediction model and the rules for constructing the prompt sentence based on the execution results or evaluations. For updating the prediction model, the server incorporates new examples into a training set, recomputes loss values, and performs additional weight updates using the same error function and optimizer previously used. For updating the prompt construction rules, the server analyzes which prompt structures lead to high evaluation scores and which lead to low scores, and adjusts the template selection logic, such as changing the order of presenting indicators, adding explicit constraints on risk level, or including more explicit instructions about the desired format of the generative AI output.

This configuration produces technical effects beyond mere automation of human decision making. Because the server integrates prediction models and the generative AI model within a closed feedback loop and because the server uses structured numerical indicators and emotion data to dynamically construct and refine prompt sentences, the server reduces the need for repetitive manual tuning of prompts and strategies. The continuous updating of model parameters and prompt construction rules increases prediction accuracy and improves the consistency of generated strategies. The use of specific data structures for numerical features and emotion states allows the prediction models and generative AI model to share intermediate representations efficiently, which reduces memory usage and computational overhead. Additionally, by conditioning the generative AI model on quantitative indicators and user emotion states, the server avoids generating irrelevant or excessively long responses, thereby reducing network traffic and processing time.

The technical improvements extend to the control of operating equipment and the management of network resources. In the industrial example, the server uses the performance indicators to identify bottlenecks and to propose specific control actions which a human user can apply to machine controllers, such as adjusting operating schedules or maintenance intervals. By doing so, the server decreases unnecessary starts and stops of machinery, which reduces wear and power consumption. In other embodiments, the server transmits selected control parameters directly to a control system when permitted. In the communication aspect, the server aggregates local preprocessing at the terminals and sends only essential features and compressed emotion representations, rather than raw media streams, thereby reducing communication load and latency.

The described architecture is not limited to a single type of prediction model or generative AI model. In another embodiment, the server uses a sequence-to-sequence neural network as the prediction model for forecasting multi-step time-series indicators, or uses alternative transformer architectures with different numbers of attention layers or different embedding dimensions. The server may also vary the feature selection logic depending on domain, for example including additional fault codes in an equipment-monitoring context or including sentiment scores from news documents in a market-analysis context. In yet another embodiment, the terminals perform a subset of preprocessing tasks, such as local feature extraction from sensor or image data, while the server focuses on prediction, prompt construction, and generative AI inference.

The described system thus improves computer technology itself by defining specific data flows, model structures, and prompt construction rules that allow the processor in the server to efficiently couple prediction algorithms and generative AI models. The closed-loop adaptation of models and prompt rules provides a mechanism for the computing system to refine its internal processing without manual reprogramming, leading to reduced computational redundancy, improved decision quality, and more efficient use of communication and storage resources.

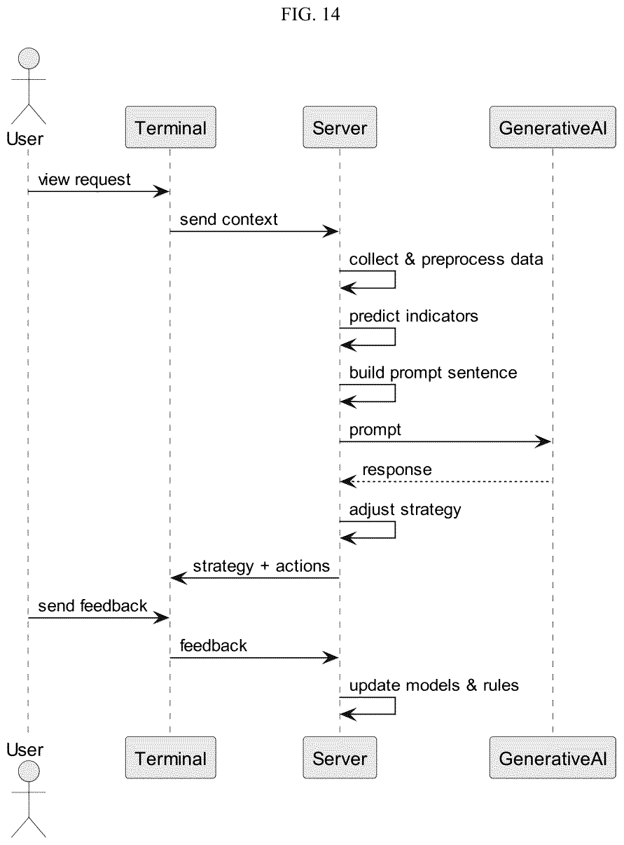

The following describes the processing flow using FIG. 14.

### Step 1:

Server acquires raw data from multiple sources.

Server uses a communication interface to receive detection signals from operating equipment (for example, sensors and controllers) and to receive external information (for example, market data and news) from network resources. Server also receives user-related data, such as audio and image streams, from Terminal. The input of this step is raw data packets that include numeric sensor readings, text documents or messages, and multimedia data (audio and video). Server parses each packet header to identify the source and timestamp, stores the payloads into appropriate raw tables or object storage, and adds indexing metadata. The output of this step is a set of stored raw records organized by data source and time.

### Step 2:

Server preprocesses sensor and external numerical data into structured numerical features.

Server loads recent raw sensor records from storage and converts them into a tabular data structure where each row corresponds to a time point and each column corresponds to a feature, such as normalized temperature, utilization ratio, or error count. The input of this step is raw measurement values with timestamps and equipment identifiers. Server applies data cleaning operations, including removal of corrupted records, interpolation of missing values based on neighboring values, and normalization of each feature to a fixed range or standardized distribution. Server also aggregates raw external numerical data, such as market indices and economic indicators, by aligning on time and converting to comparable units. The output of this step is a structured feature matrix of numerical data suitable for input to a prediction model.

### Step 3:

Server preprocesses user multimedia data into emotion data.

Server receives or loads audio and image segments from Terminal, where each segment is associated with a user identifier and time. The input of this step is raw audio waveforms and image frames. Server applies signal conditioning, including noise reduction to the audio and contrast normalization to the images. Server then extracts acoustic features, such as pitch, energy, and spectral characteristics, and facial features, such as distances between facial landmarks and motion of facial muscles. Server applies an emotion classification algorithm to these features to compute an emotion label (for example, stress, relaxed, or anxious) and a continuous emotion strength value. The output of this step is emotion data records that associate each user and time with an emotion label and an emotion strength score.

### Step 4:

Server executes a prediction model to compute performance indicators.

Server selects feature vectors from the structured numerical data that represent current and recent states of equipment and environment. The input of this step is the numerical feature matrix generated in Step 2. Server feeds these feature vectors into at least one prediction model, such as a tree-based ensemble model or a neural network model, that has been trained to output productivity indicators and market indicators. Server performs numerical computation inside the model, including weighted summations, activation function evaluations, and aggregation across model components. The output of this step is a set of performance indicators, such as predicted throughput, predicted failure probability, or forecasted market movement values, each associated with a time and context.

### Step 5:

Server synthesizes explanatory text from indicators, emotion state, and environmental context.

Server collects the performance indicators from Step 4, emotion data from Step 3, and relevant external context values, such as market volatility or social condition summaries. The input of this step is numerical indicator values, emotion labels and strengths, and selected external context fields. Server converts each numerical value into a human-readable phrase using predefined formatting rules, such as mapping 0.62 to “62% efficiency versus 85% target” or mapping a high volatility index to “market volatility is high.” Server also converts the emotion label and strength into a phrase such as “the decision-maker is under high stress.” Server concatenates these phrases into coherent explanatory text segments, taking into account order, grouping, and language rules. The output of this step is one or more explanatory text strings that describe the current state in natural language.

### Step 6:

Server constructs a prompt sentence for the generative AI model.

Server selects a prompt template based on current indicators and emotion state, such as conservative or aggressive templates, and populates template fields using the explanatory text produced in Step 5. The input of this step is explanatory text strings, template definitions, and configuration parameters such as desired output style. Server inserts the explanatory text into designated positions within the template, adds explicit instructions on whether the generative AI model should choose attack or defend, and specifies the required structure of the answer (for example, “list specific defensive measures”). Server then joins all parts into a single prompt sentence. The output of this step is a prompt sentence string that encodes the quantitative and qualitative state along with instructions for the generative AI model.

### Step 7:

Server performs generative AI model inference using the prompt sentence.

Server tokenizes the prompt sentence according to the input specification of the generative AI model and converts the text into a sequence of tokens or embeddings. The input of this step is the prompt sentence string and the parameters of the generative AI model. Server feeds the tokens into the generative AI model, which executes a sequence of mathematical operations, such as attention weight computation, linear transformations, and non-linear activations, across multiple layers. Server uses a generation algorithm, such as sampling or greedy decoding, to produce an output token sequence representing the response. Server decodes the tokens back into a text string. The output of this step is a generated text that includes at least a strategic judgment indicating attack or defend and one or more detailed action plans.

### Step 8:

Server post-processes the generated response using prediction and emotion conditions.

Server analyzes the generated text to identify explicit or implicit strategic judgments and to extract the proposed action plans. The input of this step is the generated text from Step 7, the performance indicators from Step 4, and the emotion data from Step 3. Server applies a set of decision rules that use thresholds on predicted risk, desired performance, and emotion strength to evaluate the appropriateness of attack or defend recommendations. Server adjusts, filters, or re-orders the recommended actions when conditions indicate that an overly aggressive or overly conservative plan is unsuitable. For example, if predicted failure probability is high and user stress is high, Server reduces aggressive expansion actions and emphasizes stabilization actions. The output of this step is an adjusted strategic judgment and a list of adjusted action plans that satisfy the conditions derived from the indicators and emotion data.

### Step 9:

Server transmits adjusted strategies to Terminal and records them.

Server formats the adjusted strategic judgment and action plans into a response object suitable for presentation at Terminal. The input of this step is the adjusted judgment and adjusted actions from Step 8. Server includes a summary field, detailed step descriptions, and optional metadata such as estimated risk or expected improvement. Server sends this response via the communication interface to the appropriate Terminal associated with the user. Server also writes a log entry associating the prompt sentence, generated response, and adjusted strategies into persistent storage. The output of this step is a delivered message to Terminal and a stored record of the recommendation.

### Step 10:

Terminal presents strategies to User and collects feedback.

Terminal receives the response from Server and interprets the included fields. The input of this step is the response object containing the adjusted strategic judgment and action plans. Terminal renders the summary decision on a display area, for example using distinct visual indicators for attack or defend, and renders detailed actions in a list or page view. Terminal also provides input controls, such as buttons or form fields, enabling User to report execution status (for example, completed, partially completed, or not executed) and to provide evaluation such as a numeric rating or text comment. The output of this step is displayed information visible to User and a set of feedback data entered by User.

### Step 11:

User executes or modifies actions and supplies feedback.

User reads or listens to the strategies displayed by Terminal and decides how to apply them in the real environment. The input of this step is the presented strategic judgment and action plans. User may adjust machine schedules, change allocation of resources, or alter investment parameters according to the recommended actions, or may adapt them to local constraints. User then uses Terminal to register execution results, such as whether targets were achieved, and to evaluate usefulness, for example by assigning a rating or writing a justification. The output of this step is human-generated feedback data reflecting real-world execution and subjective evaluation.

### Step 12:

Server updates models and prompt construction rules based on feedback.

Server receives feedback data from Terminal and links it with the corresponding stored prompt sentence, prediction outputs, and generative AI responses. The input of this step is the feedback records from Step 11 together with logged historical data. Server computes error metrics comparing predicted performance indicators with actual performance data derived from execution results, and computes quality metrics comparing user evaluations with internal scoring. Server uses these metrics to adjust at least one prediction model, for example by performing additional training iterations with new labeled examples, and to refine rules for prompt sentence construction, such as changing which indicators are emphasized or modifying templates for high-stress situations. The output of this step is an updated set of model parameters and updated prompt construction rules, which will be used by Server in subsequent executions to improve prediction accuracy and the relevance and stability of generated strategies.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

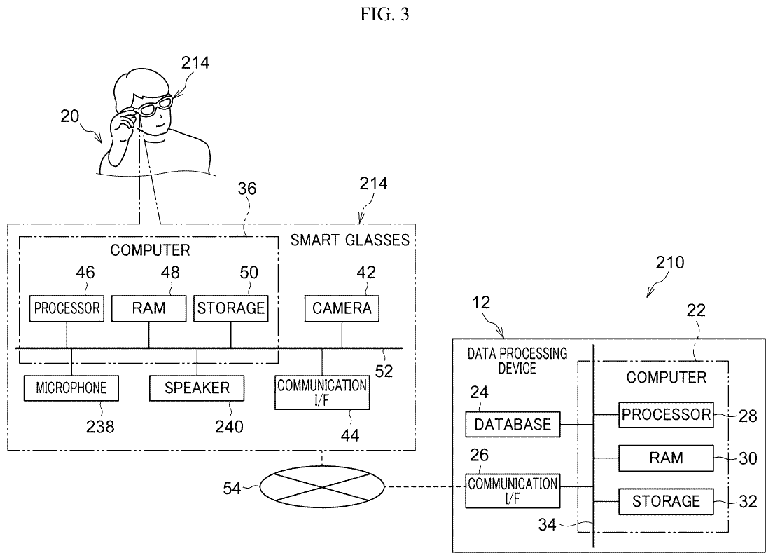

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

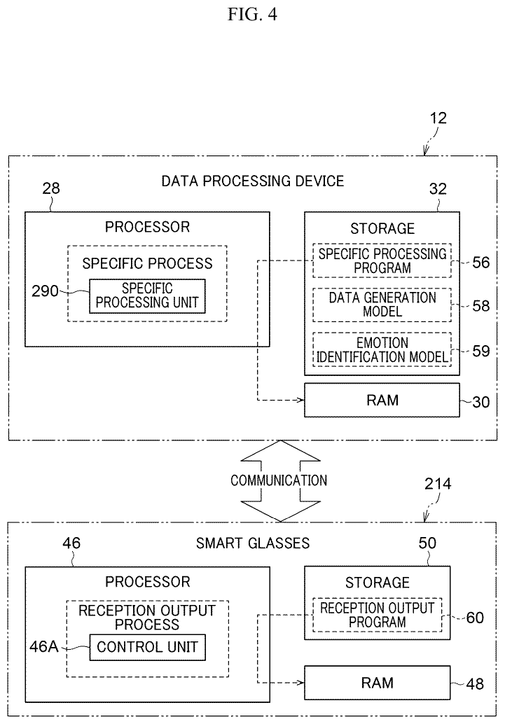

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

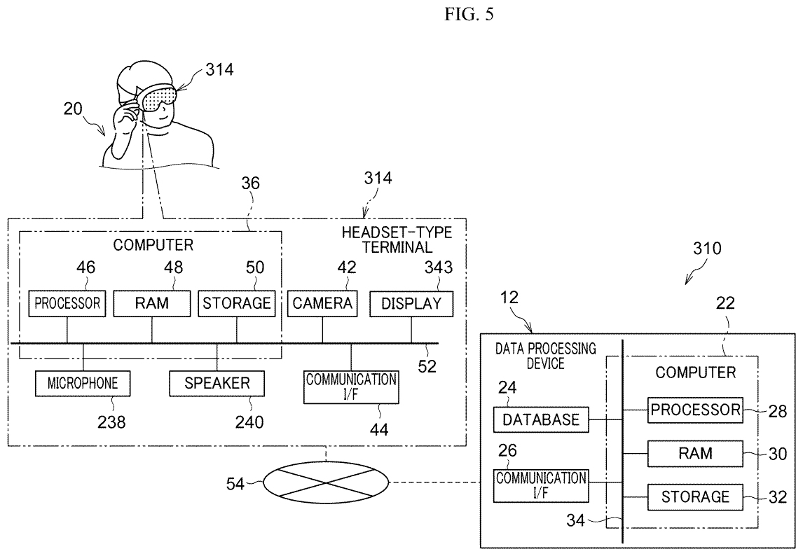

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

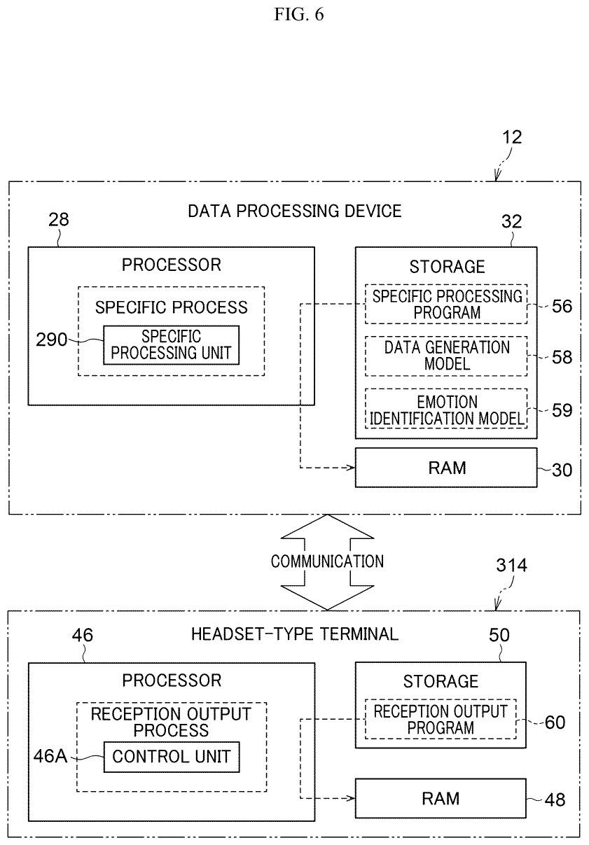

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

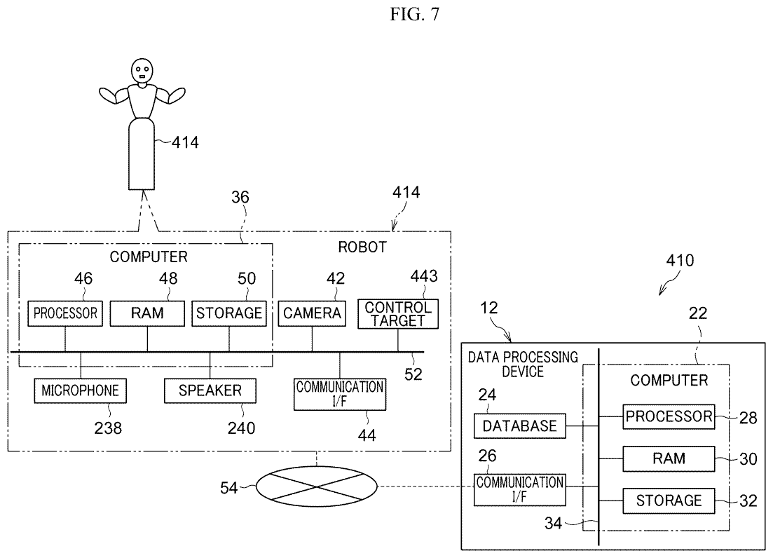

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

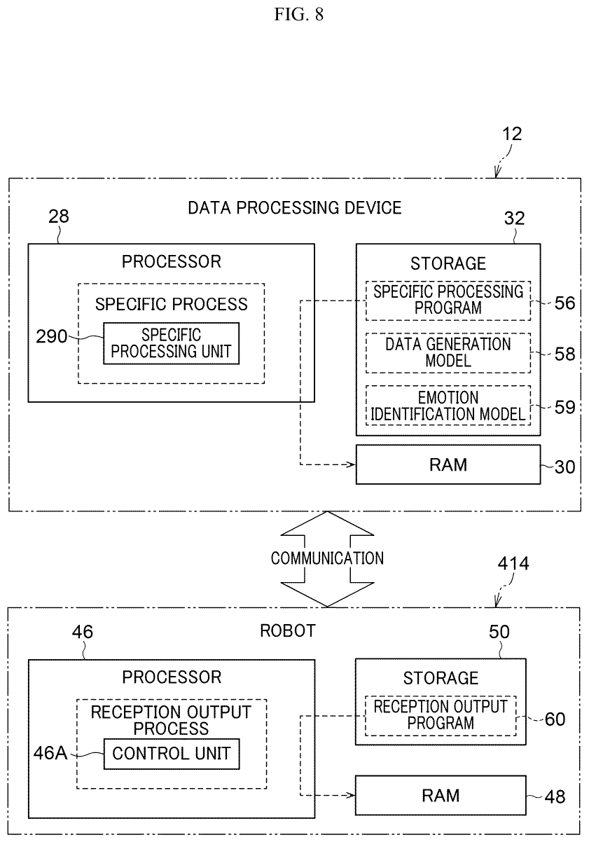

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

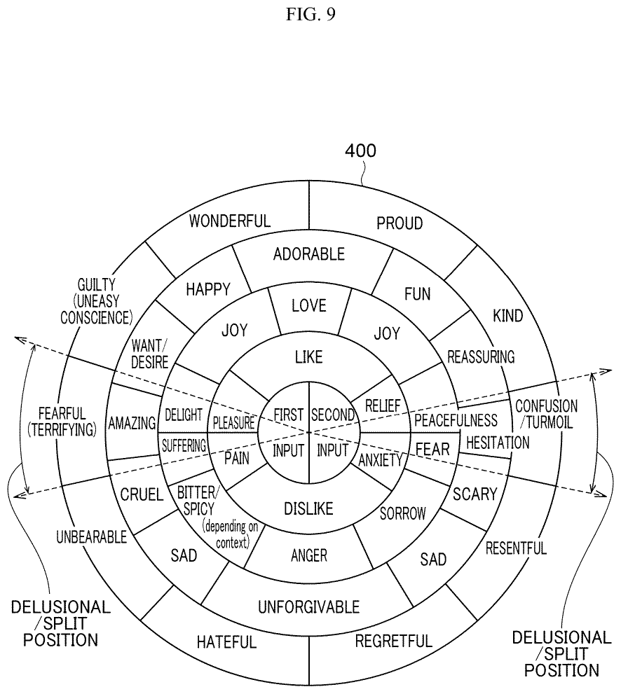

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

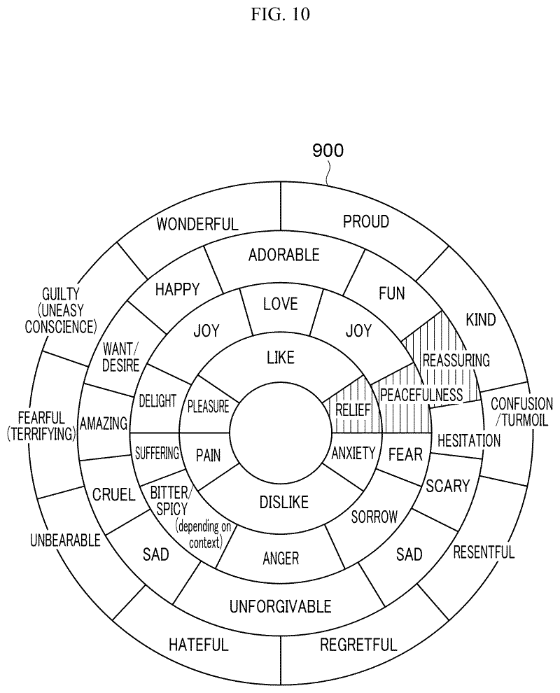

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor and a storage device,
wherein the processor is configured to
obtain, from a terminal, business information or environmental information used for strategic decision making, and store the business information or the environmental information in the storage device,
obtain, from the storage device, the business information or the environmental information, and perform preprocessing on the business information or the environmental information by using a numerical computation program and a data analysis program, the preprocessing including at least completion of missing values, removal of abnormal values, and normalization, and generate summary information including indicator values representing at least a sales trend, a profit margin trend, a market growth rate, and a cancellation rate based on the preprocessing,
convert the summary information into an explanatory text in a natural language, and generate a prompt sentence including the explanatory text and an instruction sentence, the instruction sentence instructing a generative information processing model to (i) select whether an offensive strategy “attack” or a defensive strategy “defend” is to be taken as a strategic decision and (ii) present specific measures consistent with the strategic decision,
transmit the prompt sentence to the generative information processing model provided internally in the system or externally to the system, and obtain, from the generative information processing model, a response sentence including at least one of “attack” and “defend” as the strategic decision, reasons for the strategic decision, and a plurality of proposed measures,
extract, from the response sentence, the strategic decision, the reasons, and the proposed measures, and, when the strategic decision is “defend”, obtain past business information and past measure execution results from the storage device, and specify a protection measure by correcting or adding to the proposed measures based on the past measure execution results,
generate strategy proposal information including the strategic decision, the reasons, and at least one of the protection measure and an offensive measure, transmit the strategy proposal information to the terminal, obtain, from the terminal, feedback information including adoption information and execution result information regarding the strategy proposal information, and store the feedback information in the storage device, and
generate learning data for improving a prompt sentence to be transmitted thereafter by updating at least one of a structure of the prompt sentence and a condition to be given to the generative information processing model, based on the feedback information and the business information or the environmental information.

### (Supplementary 2)

The system according to supplementary 1,
wherein the processor is configured to
display, on the terminal, a management index input screen and a risk factor input screen by using a display control program for an administrator, obtain, from the terminal, management indexes and risk factors as the business information, and generate the prompt sentence so as to include, in the prompt sentence, an explanatory text that emphasizes the management indexes and the risk factors.

### (Supplementary 3)

The system according to supplementary 1,
wherein the processor is configured to
obtain, from an external information providing apparatus, market information and competitor information as the environmental information at predetermined time intervals, sequentially store the market information and the competitor information in the storage device, dynamically update the summary information and the prompt sentence in accordance with changes in the market information and the competitor information, and repeatedly transmit the dynamically updated prompt sentence to the generative information processing model to obtain the strategic decision that changes over time.

### Application Example 1

### (Supplementary 1)

A system comprising a processor and a memory,
wherein the processor is configured to
acquire time-series information related to production activities from observation devices, and store the acquired time-series information in the memory,
perform missing-value completion, noise reduction, normalization, and feature extraction on the time-series information to generate structured information representing states of respective production processes,
calculate numerical information including operation indices and quality indices for the respective production processes based on the structured information, and generate a prompt sentence by embedding the numerical information into a natural-language format,
provide the prompt sentence and the structured information as input to a generative AI model, and cause the generative AI model to execute computation to determine, for each production process, at least one of an attack enhancement target and a defense maintenance target,
analyze a natural-language expression output from the generative AI model, extract recommended content indicating, for each production process, an attack enhancement action or a defense maintenance action, and generate structured data including, for each production process, a process identifier, an action type, and a priority,
retrieve, from an information storage unit storing past production history information, failure information, and countermeasure information, a similar case corresponding to a current production state, summarize a candidate management defense measure based on the similar case, generate an additional prompt sentence including a result of the summarization, and
provide the additional prompt sentence to the generative AI model to cause the generative AI model to generate a defense strategy including a risk-reduction measure,
integrate the attack enhancement action and the defense strategy, associate the integrated result with management indices and production indices, and output strategy proposal information to an external device, and
receive, from the external device, approval information or modification request information from a user regarding the strategy proposal information, store the approval information or the modification request information in association with the strategy proposal information, and
update at least one of the generative AI model and the feature extraction processing based on a result of the storing.

### (Supplementary 2)

The system according to supplementary 1,
wherein the processor is configured to
receive, via an information display device for a management layer or an administration layer, input including management indices, constraint conditions, and target production processes, and add the input to the prompt sentence and the additional prompt sentence so as to dynamically control generation conditions of the attack enhancement action and the defense strategy by the generative AI model.

### (Supplementary 3)

### The System According to Supplementary 1,

wherein the processor is configured to
sequentially update external information related to a production environment, the external information including demand information and competition information, associate the external information with the time-series information, generate a prompt sentence including the demand information and the competition information, and periodically or event-drivenly provide the prompt sentence as input to the generative AI model so that the generative AI model dynamically performs determination of the attack enhancement target and the defense maintenance target and generation of the defense strategy.

### EXAMPLE 2

### (Supplementary 1)

A system comprising a processor,
wherein the processor is configured to
acquire, via a communication function, business information and external information required for strategic decision making from a plurality of information sources,
preprocess the acquired business information and external information by executing data processing using a general-purpose program, the preprocessing including complementing missing values, removing outliers, performing normalization, and converting formats, and
structure the preprocessed data into analysis data including time-series information and attribute information,
generate, on the basis of an instruction sentence related to strategic decision making received from a user and the analysis data, a prompt sentence for input to a generative AI model, and
control input of the prompt sentence and the analysis data to the generative AI model,
obtain numerical prediction information and explanatory information in natural language output from the generative AI model, generate strategic decision information including a plurality of defensive measures in accordance with predicted values and constraint conditions while classifying an action policy of an organization into an offensive measure or a defensive measure on the basis of the numerical prediction information,
convert the strategic decision information into output data including visualization data and explanatory text, and perform output control such that a display device presents the visualization data and the explanatory text as a graph display and a list display, and
upon receiving an additional instruction sentence or a change of conditions from the user, update the prompt sentence and the analysis data, and rerun input to the generative AI model and generation of the strategic decision information to interactively update the strategic decision making.

### (Supplementary 2)

The system according to supplementary 1,
wherein the processor is configured to
receive, via a user screen for a manager or a decision maker, management indices, risk factors, and an analysis target range, and generate the prompt sentence by incorporating the management indices, the risk factors, and the analysis target range into the prompt sentence such that the generative AI model performs strategic decision making specialized for the management indices and the risk factors.

### (Supplementary 3)

The system according to supplementary 1,
wherein the processor is configured to
acquire, in real time or at a predetermined cycle, data from market-related information sources and competitor-related information sources, sequentially add and update the acquired data in the analysis data, dynamically change the prompt sentence in response to the update, and rerun an inference process by the generative AI model, thereby continuously generating the strategic decision information reflecting changes in a market environment.

### Application Example 2

### (Supplementary 1)

A system comprising a processor,
wherein the processor is configured to acquire information required for strategic decision making,
wherein the processor is configured to preprocess the acquired information and detection signals from operating equipment to generate numerical data, character data, and emotion data,
wherein the processor is configured to execute a prediction model based on the preprocessed numerical data to calculate performance indicators including at least one of productivity indicators and market indicators,
wherein the processor is configured to generate an explanatory text representing at least one of the performance indicators, a user emotion state, and an environmental state, and to construct a prompt sentence including the explanatory text,
wherein the processor is configured to input the prompt sentence into a generative artificial intelligence model and to obtain a response including a strategic judgment indicating whether to attack or to defend and including a plurality of action plans,
wherein the processor is configured to apply conditions based on the emotion data and outputs of the prediction model to the strategic judgment and the action plans included in the response, and to select and adjust at least one of a defensive measure and an offensive measure,
wherein the processor is configured to present the adjusted strategic judgment and the adjusted action plans to a user terminal through an output device, and to collect and record at least one of an execution result and an evaluation from a user, and
wherein the processor is configured to update at least one of the prediction model and rules for constructing the prompt sentence based on the execution result or the evaluation.

### (Supplementary 2)

The system according to supplementary 1,
wherein the processor is configured to receive, from a user terminal used by at least one of a management-level user and a supervisory-level user, management indicators, risk factors, and a desired explanation format, to estimate a user emotion state from at least one of user voice data and user facial image data, and to incorporate the management indicators, the risk factors, the desired explanation format, and the user emotion state into the prompt sentence, thereby instructing the generative artificial intelligence model to generate a strategic judgment adapted to at least one of the management-level user and the supervisory-level user.

### (Supplementary 3)

The system according to supplementary 1,
wherein the processor is configured to continuously acquire, as time-series external information, at least one of market information, competitor information, and social condition information, to supply acquisition results in real time to the preprocessing and the prediction model, to dynamically update the prompt sentence so as to reflect latest performance indicators including at least one of the productivity indicators and the market indicators and to reflect the user emotion state, and to repeatedly cause the generative artificial intelligence model to execute the strategic judgment and a proposal of the defensive measure.

What is claimed is:

1. A system comprising:
circuitry configured to:
receive, via a communication interface coupled to a packet-switched network, from a terminal device, first category input data and second category input data;
preprocess the first category input data and the second category input data to generate normalized indicator data;
generate, based on the normalized indicator data, a prompt sentence for instructing a generative neural network model to perform a classification of the normalized indicator data into a first action classification label or a second action classification label;
transmit, via the communication interface, the prompt sentence to the generative neural network model and receive response data comprising the classification and action recommendation data associated with the classification; and
transmit, via the communication interface, the action recommendation data to the terminal device.

2. The system according to claim 1, wherein the circuitry is further configured to:
receive, via the communication interface, from the terminal device, constraint parameter data and numerical indicator data; and
generate a second prompt sentence that includes the constraint parameter data and the numerical indicator data as conditioning parameters for the generative neural network model.

3. The system according to claim 2, wherein the circuitry is further configured to:
parse the response data to extract, for each of a plurality of process identifiers, a respective action type label and a priority value; and
generate structured recommendation data comprising the plurality of process identifiers, the respective action type labels, and the priority values.

4. The system according to claim 3, wherein the first action classification label represents an offensive strategy classification and the second action classification label represents a defensive strategy classification, and the action recommendation data comprises at least one defensive measure associated with the defensive strategy classification.

5. The system according to claim 4, wherein the first category input data comprises business information including at least one of sales data, cost data, and management indicator data, and the second category input data comprises environmental information including at least one of market data and competitive information.

6. The system according to claim 1, wherein the circuitry is further configured to:
convert the normalized indicator data into natural-language summary text; and
embed the natural-language summary text into the prompt sentence as a structured context portion of the prompt sentence.

7. The system according to claim 6, wherein the preprocessing comprises at least one of missing-value completion processing, noise reduction processing, normalization processing, and feature extraction processing applied to the first category input data and the second category input data.

8. The system according to claim 1, wherein the circuitry is further configured to:
receive, via the communication interface, from the terminal device, feedback data indicating at least one of an adoption decision and an execution result associated with the action recommendation data; and
update, based on the feedback data, at least one of a structure of the prompt sentence and a conditioning parameter supplied to the generative neural network model for generating subsequent action recommendation data.

9. The system according to claim 8, wherein the circuitry is further configured to:
store the feedback data in association with the action recommendation data and a time identifier in a storage device; and
generate learning data based on an accumulated set of the feedback data to refine prompt generation processing for subsequent prompt sentences.

10. The system according to claim 9, wherein the circuitry is further configured to:
retrieve, from the storage device, historical case data corresponding to a current state represented by the normalized indicator data; and
generate a supplementary prompt sentence including a summary of the historical case data to cause the generative neural network model to generate refined action recommendation data based on the historical case data.

11. The system according to claim 1, wherein the circuitry is further configured to:
receive, via the communication interface, the second category input data at periodic intervals; and
dynamically update the prompt sentence based on updated second category input data to cause the generative neural network model to generate updated action recommendation data responsive to changes in the second category input data.

12. The system according to claim 1, wherein the circuitry is further configured to:
acquire time-series data from a plurality of observation devices via the communication interface;
perform feature extraction on the time-series data to generate structured state data representing a plurality of operational processes; and
calculate, based on the structured state data, operation index data and quality index data for each of the plurality of operational processes.

13. The system according to claim 12, wherein the circuitry is further configured to:
generate, for each operational process, a prompt sentence embedding the operation index data and the quality index data in a natural-language format; and
cause the generative neural network model to determine, for each operational process, at least one of the first action classification label and the second action classification label.

14. The system according to claim 13, wherein the time-series data comprises production activity data acquired from sensors and controllers in a manufacturing environment, the operation index data comprises at least one of an equipment utilization rate and a throughput rate, and the quality index data comprises at least one of a defect rate and a yield rate.

15. The system according to claim 1, wherein the circuitry is further configured to:
apply a state estimation function to input signal data received from the terminal device to generate a state classification label; and
adjust at least one parameter of the prompt sentence based on the state classification label.

16. The system according to claim 15, wherein the state estimation function comprises an emotion identification model, the input signal data comprises at least one of text data, audio data, or image data captured by the terminal device, and the state classification label represents an estimated emotional state of a user.

17. The system according to claim 16, wherein the circuitry is further configured to:
integrate the state classification label with the normalized indicator data and an environmental state parameter into a unified context representation; and
construct the prompt sentence to include the unified context representation as a conditioning input for the generative neural network model.

18. The system according to claim 1, wherein:
the circuitry is configured to:
receive, via the communication interface coupled to the packet-switched network, from the terminal device, the first category input data and the second category input data;
preprocess the first category input data and the second category input data to generate the normalized indicator data;
convert the normalized indicator data into natural-language summary text;
generate the prompt sentence including the natural-language summary text and an explicit instruction for the generative neural network model to perform the classification;
transmit the prompt sentence to the generative neural network model and receive the response data;
parse the response data to extract the classification, a reasoning portion, and the action recommendation data; and
transmit the action recommendation data to the terminal device as structured proposal data.

19. The system according to claim 18, wherein the circuitry is further configured to:
receive feedback data from the terminal device indicating an adoption decision; and
update at least one of a structure of a subsequent prompt sentence and a conditioning parameter for the generative neural network model based on the feedback data.

20. A method performed by circuitry, the method comprising:
receiving, via a communication interface coupled to a packet-switched network, from a terminal device, first category input data and second category input data;
preprocessing the first category input data and the second category input data to generate normalized indicator data;
generating, based on the normalized indicator data, a prompt sentence for instructing a generative neural network model to perform a classification of the normalized indicator data into a first action classification label or a second action classification label;
transmitting, via the communication interface, the prompt sentence to the generative neural network model and receiving response data comprising the classification and action recommendation data associated with the classification; and
transmitting, via the communication interface, the action recommendation data to the terminal device.
